(19) United States
(12) Patent Application Publication
(10) Pub. No.: US 2026/0082272 A1
(43) Pub. Date: Mar. 19, 2026

(54) MANAGING DISAGGREGATED RADIO ACCESS NETWORKS

(71) Applicant: DISH Wireless L.L.C., Englewood, CO (US)

(72) Inventor: Madhuri Muttreja, Parker, CO (US)

(21) Appl. No.: 19/331,334

(22) Filed: Sep. 17, 2025

Related U.S. Application Data
(60) Provisional application No. 63/696,083, filed on Sep. 18, 2024.

(51) Int. Cl. H04W 28/06; H04W 24/02; H04W 28/26

(52) U.S. Cl. CPC H04W 28/06; H04W 28/26; H04W 24/02

(57) ABSTRACT

A computer-implemented method is disclosed for telemetry-driven orchestration in a next-generation cellular network. The method includes instantiating, via one or more processors, a message bus logically associated with a telemetry producer comprising a plurality of individually managed sub-producers. Each sub-producer generates telemetry data, a subset of which is forwarded to a radio access network intelligent controller (RIC) based on data type classification. The method further includes transmitting first and second telemetry data of the same type from respective sub-producers to the RIC via the message bus. Based on the received telemetry, the RIC generates a recommendation for altering components of the system. The method then generates configuration instructions defining one or more operational parameters and applies those instructions to transition at least one operational parameter from an initial state to a revised state. This enables adaptive, data-driven network optimization through automated configuration updates informed by real-time telemetry analysis.

### RELATED APPLICATIONS

This application claims the benefit of U.S. Patent Application No. 63/696,083, filed Sep. 18, 2024, the entire contents of which are incorporated herein by reference.

### BACKGROUND

This disclosure relates to wireless data networks. Wireless data networks that transport digital data and telephone calls are becoming increasingly sophisticated. Currently, fifth generation (5G) broadband cellular networks are being deployed worldwide. These networks use emerging technologies to support data and voice communications for millions, if not billions, of mobile phones, computers, and other devices. 5G technologies are capable of supplying much greater bandwidth than previously available technologies. In addition, it is expected that higher data rates may be required in 6G and subsequent generations.

These wireless data networks may collect and distribute more data than previous generations. Centralizing large volumes of data is expensive and time-consuming, which may reduce the speed advantages offered by 5G networks.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of a cellular network system implementing a message bus system in a cellular network, according to at least one embodiment.

FIG. 2 is a block diagram of a system implementing one or more message buses within a cellular network, according to at least one embodiment.

FIG. 3 is a block diagram of a system implementing one or more message buses within a cellular network, according to at least one embodiment.

FIG. 4 is a block diagram of one or more producers utilizing one or more message buses within the cellular network, according to at least one embodiment.

FIG. 5 is a block diagram of one or more consumers utilizing one or more message buses within the system, according to at least one embodiment.

FIG. 6 is a block diagram of smart message bus utilization for connecting one or more producers to one or more consumers, according to at least one embodiment.

FIG. 7 is a block diagram of message buses within a central system, at an edge distribution center, and in cloud storage, according to at least one embodiment.

FIG. 8 is a block diagram of telecommunication edge channels deployed for edge distribution center capabilities, according to at least one embodiment.

FIG. 9 illustrates an example graphical user interface for data producers connecting to the message buses of FIG. 2, according to at least one embodiment.

FIG. 10 illustrates an example graphical user interface for data consumers connecting to the message buses of FIG. 2, according to at least one embodiment.

FIG. 11 is a logical flow diagram for smart producer and consumer configuration of message bus connection architecture, according to at least one embodiment.

FIG. 12 is an illustrative topic governance logic table for next-generation data configuration, according to at least one embodiment.

FIG. 13 is a flow diagram of a method for providing real-time and non-real-time service communication channels, according to at least one embodiment.

FIG. 14 is a flow diagram of a method for intelligent communication channel generation for next-generation data transmission, according to at least one embodiment.

FIG. 15 is a flow diagram of a method for connecting clients to a message bus, according to at least one embodiment.

FIG. 16 is a flow diagram of a method of selecting and providing message buses at edge telecommunication locations, according to at least one embodiment.

FIG. 17 is a flow diagram of a method of identifying data for message bus transmission based on topic governance rules, according to at least one embodiment.

FIG. 18 is a flow diagram of a method of utilizing message bus transmission for RIC operations, according to at least one embodiment.

### DETAILED DESCRIPTION

Technologies for enabling scalable, high-throughput data communications in O-RAN data collection systems within cellular networks (e.g., 5G and 6G wireless networks) are described. The following description provides numerous specific details, including examples of particular systems, components, and methods, to facilitate a clear understanding of several embodiments of the present disclosure. However, it will be apparent to those skilled in the art that at least some embodiments of the present disclosure may be practiced without these specific details. In other instances, well-known components or methods are not described in detail or are presented in simple block diagram format to avoid unnecessarily obscuring the present disclosure. Thus, the specific details set forth are merely exemplary. Particular implementations may vary from these examples and are still considered within the scope of the present disclosure.

As described above, the collection and distribution of data using current and next-generation transmission technologies (e.g., 5G, 6G) may require increased storage capacity and may result in slower transmission rates. Aspects and embodiments of the present disclosure address these and other challenges by enabling non-physical connections between data producers and consumers, thereby facilitating the transmission of large volumes of data. Specifically, within open radio access network (O-RAN) data collection systems, data producers may be segmented into sub-producers that require specialized data transmission and storage methods to enable consumers to access and utilize the segmented data.

Telecommunication systems, particularly those utilizing 4G and earlier network generations, typically employ vertically integrated and proprietary radio access network (RAN) components. These RAN architectures often consist of tightly coupled elements such as the Radio Unit (RU), Distributed Unit (DU), and Centralized Unit (CU), all provided by a single vendor. This design results in a monolithic, inflexible network structure with limited interoperability between components. Additionally, the inability to independently scale and upgrade these components has limited innovation and cost efficiency.

The advent of 5G and the transition toward 6G networks, however, demand increased flexibility, scalability, and interoperability. Open RAN (O-RAN) enables the disaggregation of the RAN into separate, modular components that may operate independently while communicating via standardized, open interfaces. This disaggregation allows for multi-vendor solutions, more efficient resource allocation, and the ability to tailor the network to specific use cases and geographic needs.

However, the disaggregation of RAN components results in a significant increase in the volume and complexity of the data being produced. The increased volume of data generated by these network elements creates substantial challenges for data management, network optimization, and infrastructure requirements. Improved data communication methods are required to monitor the health and functionality of the telecommunication network (also referred to as the ‘telecom network’). Furthermore, the scale of the data produced by disaggregated RAN components necessitates advanced data processing capabilities and the integration of technologies such as Artificial Intelligence (AI), Machine Learning (ML), and edge computing.

The increased technical demands caused by greater data generation and variability require advancements in data transmission technology within O-RAN-enabled systems. These advancements may include systems capable of transmitting and processing both real-time and non-real-time data, deploying data transmission modules at edge computing devices, and rapidly generating such modules for edge deployment. Technological improvements in data transmission may also include systems that can transmit and process both real-time and non-real-time data, deploy data transmission modules at edge computing devices, quickly and efficiently generate data transmission modules for edge deployment, enable the transmission of O-RAN vendor-generated data using common governance terms, and similar enhancements.

Aspects of the present disclosure describe systems and methods for enabling scalable, low-latency, and high-throughput data transmission in disaggregated RAN (e.g., O-RAN) systems, which are critical for next-generation networks such as 5G, 6G, and beyond. The disclosed architecture utilizes one or more managed message buses as a decoupled communication layer between data producers—such as user equipment (UEs), radio units (RUS), distributed units (DUs), and centralized units (CUs)—and various consumers, including real-time analytics engines, orchestration components, and modular applications. Optional data stores may be integrated for persistence, but the architecture is designed to avoid reliance on central storage, enabling more efficient and resilient communication.

By leveraging message buses, producers can transmit data to one or more consumers without the need for direct or persistent point-to-point connections. This supports scalable data flow and simplifies communication in multi-vendor environments, where the volume and variety of telemetry data have increased significantly. Producers may include sub-producers (e.g., embedded sensors) that generate localized telemetry, which is classified and transmitted via the message bus.

A RAN Intelligent Controller (RIC), either centralized or distributed, ingests this telemetry for both near-real-time operations (e.g., scheduling, interference mitigation) and non-real-time functions (e.g., AI/ML-driven planning and policy enforcement). These insights are made available to consumers through modular applications that analyze performance, detect anomalies, and generate optimization recommendations. The recommendations are forwarded to network management components such as the Element Management System (EMS) and Configuration Manager (CM), and may be deployed via a Continuous Integration/Continuous Deployment (CI/CD) pipeline for automated system updates.

The system includes a controller that manages connections to message buses and enables dynamic rerouting in case of bus failures, ensuring uninterrupted telemetry flow. This flexible architecture supports message bus deployment across various tiers of the network, including local, regional, back-end, and edge data centers. Pre-generated message buses may be provisioned at the edge to reduce latency and minimize provisioning delays, enhancing the responsiveness of analytics and operational systems.

Furthermore, robust topic governance mechanisms are implemented to ensure that each consumer receives only relevant telemetry data, which reduces unnecessary data transmission and improves the accuracy and timeliness of insights. This governance model becomes increasingly vital as the volume of telemetry data grows, helping to prevent data floods and ensuring that critical health and operational data are efficiently routed to appropriate consumers.

By enabling distributed, resilient, and intelligent telemetry management, the disclosed systems and methods offer a scalable foundation for real-time and near-real-time data communication. This facilitates enhanced visibility into network performance, faster identification of anomalies or failures, and supports the operational demands of evolving multi-vendor, disaggregated RAN deployments.

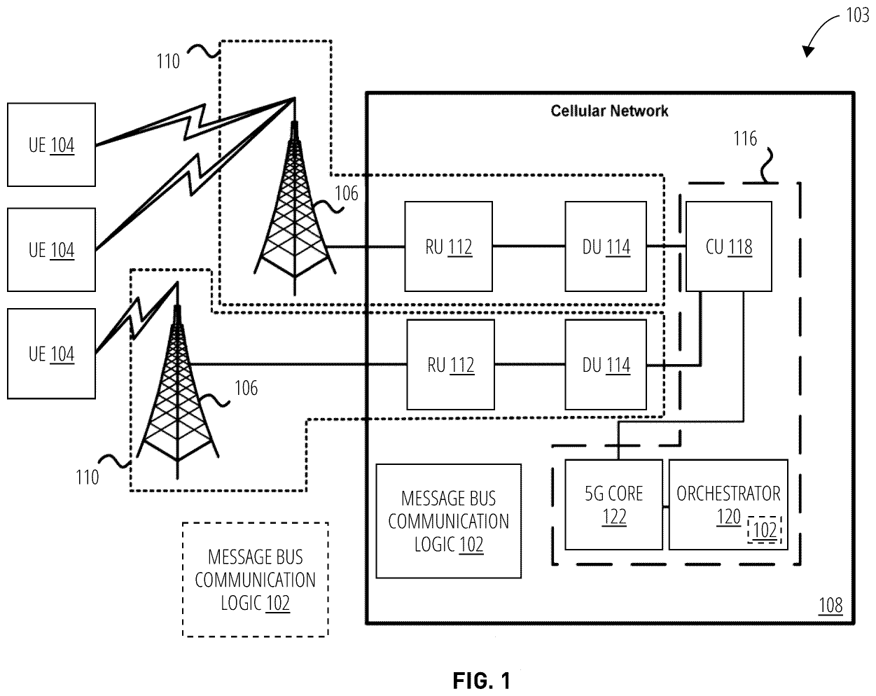

FIG. 1 is a block diagram of a cellular network system 103 (“system 103”) implementing a message bus system in a cellular network, according to at least one embodiment. FIG. 1 represents an embodiment of a cellular network that may accommodate a cloud-based architecture. System 103 may include a 5G New Radio (NR) cellular network; other types of cellular networks, such as 6G, 7G, etc., may also be possible. System 103 may include: UEs 104; base station structure 106 including base station equipment (i.e., base station 110); cellular network 108; radio units 112 (“RUs 112”); distributed units 114 (“DUs 114”); centralized unit 118 (“CU 118”); 5G core 122; and orchestrator 120. FIG. 1 represents a component-level view. In an open radio access network (O-RAN), components may be implemented as specialized software executed on general-purpose hardware, except for components that need to receive and transmit radio frequency (RF) signals. The functionality of the various components may be shifted among different servers. For at least some components, the hardware may be maintained by a separate cloud-service provider to accommodate where the functionality of such components is needed.

UE 104 may represent various types of end-user devices, such as cellular phones, smartphones, cellular modems, cellular-enabled computerized devices, sensor devices, gaming devices, access points (APs), or any computerized device capable of communicating via a cellular network. Generally, a UE may represent any type of device that has an integrated 5G interface, such as a 5G modem. Examples may include sensor devices, Internet of Things (IoT) devices, manufacturing robots, unmanned aerial (or land-based) vehicles, network-connected vehicles, etc. Depending on their location, individual UEs 104 may use RF to communicate with various base stations in cellular network 108. For example, base station 110 may include a base station structure 106, a radio unit (RU) 112, and a distributed unit (DU) 114. Base station structure 106 may be any structure to which one or more antennas (not illustrated) of the base station are mounted. Base station structure 106 may be a dedicated cellular tower, a building, a water tower, or any other human-made or natural structure to which one or more antennas may reasonably be mounted to provide cellular coverage to a geographic area. Similarly, base station 110 may include: base station structure 106, RU 112, and DU 114.

Real-world implementations of system 103 may include many (e.g., thousands) of base stations, as well as many CUs and 5G core 122 instances. Base station structure 106 may include one or more antennas that allow RUs 112 to communicate wirelessly with UEs 104. RUs 112 may represent the edge of cellular network 108, where data is transitioned to wireless communication. The radio access technology (RAT) used by RU 112 may be 5G New Radio (NR) or another RAT. The remainder of cellular network 108 may be based on an exclusive 5G architecture, a hybrid 4G/5G architecture, a 4G architecture, or another cellular network architecture. Base station 110 may include an RU 112 and a DU 114.

One or more RUs 112 may communicate with a DU 114. For example, at a possible cell site, three RUs may be present, each connected to the same DU. Different RUs may be present for different portions of the spectrum. For instance, a first RU may operate on the spectrum in the Citizens Broadband Radio Service (CBRS) band, while a second RU may operate on a separate portion of the spectrum, such as band 71. One or more DUs 114 may communicate with CU 118. Collectively, an RU, DU, and CU create a gNodeB, which serves as the radio access network (RAN) of cellular network 108. CU 118 may communicate with 5G core 122. The specific architecture of cellular network 108 may vary by embodiment. Edge cloud server systems outside of cellular network 108 may communicate, either directly, via the Internet, or via another network, with components of cellular network 108. For example, DU 114 may be able to communicate with an edge cloud server system without routing data through CU 118 or 5G core 122. Other DUs may or may not have this capability.

While FIG. 1 illustrates various components of cellular network 108, other embodiments of cellular network 108 may vary in arrangement, communication paths, and specific components. While RU 112 may include specialized radio access components to enable wireless communication with UE 104, other components of cellular network 108 may be implemented using specialized hardware, specialized firmware, and/or specialized software executed on a general-purpose server system. In an O-RAN arrangement, specialized software running on general-purpose hardware may be used to perform the functions of components such as DU 114, CU 118, and 5G core 122. The functionality of these components may be co-located or distributed across different physical server systems. For example, certain components of 5G core 122 may be co-located with components of CU 118.

In a possible virtualized O-RAN implementation, CU 118, 5G core 122, and/or orchestrator 120 may be implemented as software executed by general-purpose computing equipment, such as in a data center of a cloud-computing platform, as detailed herein. Therefore, depending on needs, the functionality of a CU and/or 5G core may be implemented locally to each other, and specific functions of any given component may be performed by physically separated server systems (e.g., at different server farms). For example, some functions of a CU may be located at the same server facility where the DU is executed, while other functions are executed at a separate server system. In the illustrated embodiment of system 103, cloud-based cellular network components 116 include CU 118, 5G core 122, and orchestrator 120. These cloud-based cellular network components 116 may be executed as specialized software running on underlying general-purpose computer servers. Cloud-based cellular network components 116 may be executed on a third-party cloud-based computing platform or a cloud-based computing platform operated by the same entity that operates the RAN. A cloud-based computing platform may have the ability to allocate additional hardware resources to cloud-based cellular network components 116 or implement additional instances of such components when requested.

Kubernetes, or another container orchestration platform, may be used to create and destroy logical CU or 5G core units and subunits as needed for cellular network 108 to function properly. Kubernetes allows for container deployment, scaling, and management. For example, if cellular traffic increases substantially in a region, an additional logical CU or components of a CU may be deployed in a data center near where the traffic is occurring without any new hardware being deployed. Instead, the processing and storage capabilities of the data center would be devoted to the needed functions. When the need for the logical CU or its subcomponents no longer exists, Kubernetes may allow for their removal. Kubernetes may also be used to control the flow of data (e.g., messages) and inject data flows to various components. This arrangement may allow for the modification of the nominal behavior of various layers.

The deployment, scaling, and management of such virtualized components may be managed by orchestrator 120. Orchestrator 120 may represent various software processes executed by underlying computer hardware. Orchestrator 120 may monitor cellular network 108 and determine the amount and location at which cellular network functions should be deployed to meet or attempt to meet service level agreements (SLAs) across slices of the cellular network.

Orchestrator 120 may allow for the instantiation of new cloud-based components of cellular network 108. For example, to instantiate a new core function, orchestrator 120 may perform a pipeline that includes calling the core function code from a software repository incorporated as part of, or separate from, cellular network 108; pulling corresponding configuration files (e.g., Helm charts); creating Kubernetes nodes/pods; loading the related core function containers; configuring the core function; and activating other support functions (e.g., Prometheus, instances/connections to test tools).

A network slice functions as a virtual network operating on cellular network 108. Cellular network 108 is shared with numerous other network slices, potentially numbering in the hundreds or thousands. Communication bandwidth and computing resources of the underlying physical network may be reserved for individual network slices, allowing each slice to reliably meet defined SLA parameters. By controlling the location and amount of computing and communication resources allocated to a network slice, the quality of service (QoS) and quality of experience (QoE) for UE may vary across different slices. A network slice may be configured to provide sufficient resources for a particular application to be properly executed and delivered (e.g., gaming services, video services, voice services, location services, sensor reporting services, data services, etc.). However, resources are not infinite, so allocating excessive resources to a particular UE group and/or application should be avoided. Additionally, a cost may be attached to cellular slices: the greater the amount of resources dedicated, the higher the cost to the user; thus, optimization between performance and cost is desirable.

Certain network slices may only be reserved in specific geographic regions. For instance, a first set of network slices may be present at RU 112 and DU 114, while a second set of network slices—which may only partially overlap or may be entirely different from the first set—may be reserved at another RU 112 and DU 114.

Furthermore, particular cellular network slices may include a number of defined layers. Each layer within a network slice may be used to define QoS parameters and other network configurations for specific types of data. For example, high-priority data sent by a UE may be mapped to a layer with relatively higher QoS parameters and network configurations, while lower-priority data sent by the UE may be mapped to a second layer with less stringent QoS parameters and different network configurations.

Components such as DUs 114, CU 118, orchestrator 120, and 5G core 122 may include various software elements that are required to communicate with each other, handle large volumes of data traffic, and properly respond to changes in the network. To ensure not only the functionality and interoperability of these components, but also their ability to respond to changing network conditions and to meet or exceed vendor specifications, significant testing must be performed.

5G core 122, which may be physically distributed across data centers or located at a central national data center (NDC), may perform various core functions of the cellular network. 5G core 122 may include: network resource management components; policy management components; subscriber management components; and packet control components. Individual components may communicate on a bus, allowing various components of 5G core 122 to interact directly. 5G core 122 is simplified here to show some key components; implementations may involve additional components.

Network resource management components may include network repository function (NRF) and network slice selection function (NSSF). NRF may allow 5G network functions (NFs) to register and discover each other via a standards-based application programming interface (API). NSSF may be used by the access and mobility management function (AMF) to assist with the selection of a network slice that may serve a particular UE.

Policy management components may include charging function (CHF) and policy control function (PCF). CHF allows charging services to be offered to authorized network functions. Converged online and offline charging may be supported. PCF enables policy control functions and supports the related 5G signaling interfaces.

Subscriber management components may include Unified Data Management (UDM) and Authentication Server Function (AUSF). UDM may allow for the generation of authentication vectors, user identification handling, NF registration management, and retrieval of UE individual subscription data for slice selection. AUSF performs authentication with the UE.

Packet control components may include Access and Mobility Management Function (AMF) and Session Management Function (SMF). AMF may receive connection—and session-related information from the UE and is responsible for handling connection and mobility management tasks. SMF is responsible for interacting with the decoupled data plane, creating, updating, and removing Protocol Data Unit (PDU) sessions, and managing session context with the User Plane Function (UPF).

User Plane Function (UPF) may be responsible for packet routing and forwarding, packet inspection, QoS handling, and external PDU sessions for interconnecting with a Data Network (DN) (e.g., the Internet) or various access networks. Access networks may include the RAN of cellular network 108.

The 5G core 122 may reside on a cloud computing platform. While from a client's or user's point of view, the “cloud” may be envisioned as an ephemeral computing workspace that occupies no physical space, in reality, a cloud computing platform is an interconnected group of data centers throughout which computing and storage resources are distributed. Therefore, data centers may be scattered geographically and may provide redundancy. As used herein, “client” may refer to an end system or device working autonomously or at the direction of a user. A client may be, for example, a client device, user terminal, cloud service subscriber, etc. A client may be a data producer or a data consumer for telecommunication network data. A data producer may comprise one or more O-RAN components that produce data, which may be considered a client either individually or as a group. A client may also be storage within a cloud computing environment.

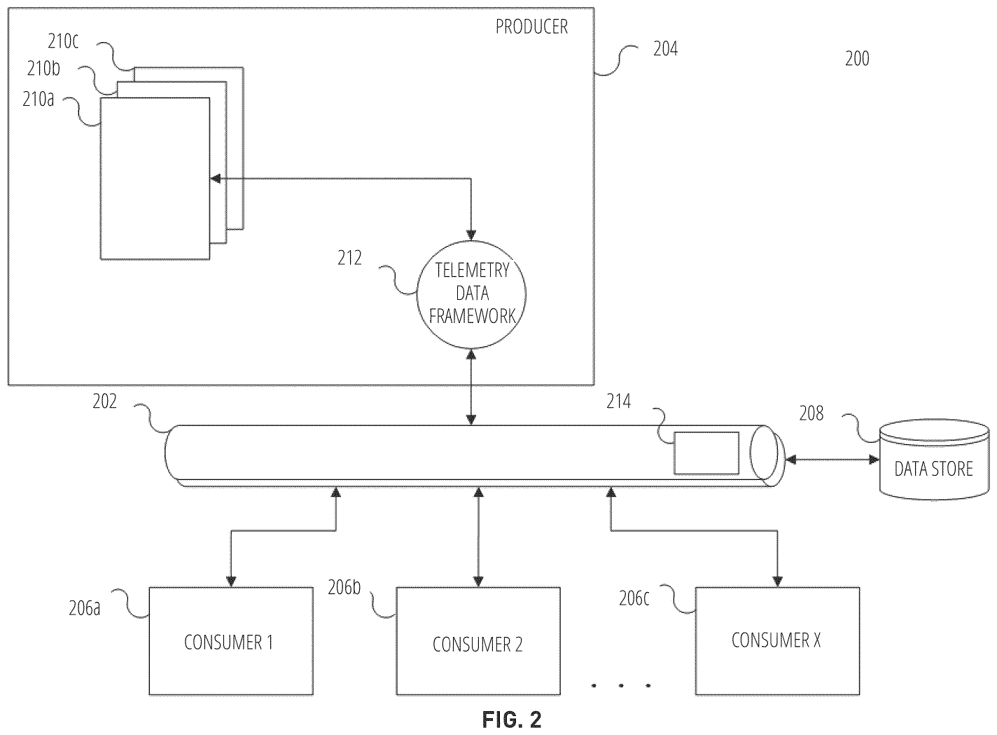

As illustrated below in FIGS. 2-8, the system 103 includes the message bus communication logic 102 as described above with respect to FIG. 2 to FIG. 8. In some embodiments, the system 103 may be a next-generation telecommunication system such as, for example, 5G, 6G, and the like. Within next-generation systems, data producers such as RUs 112, DUs 114, CUs 118, and the like may be multi-vendor components that generate more usable data for data consumption than traditional telecommunication system components. To manage communication of the large amounts of data in next-generation telecommunication systems, the system 103 may implement the message bus communication logic 102 to facilitate the flow of data from the O-RAN data producers and data consumers. The message bus communication logic 102 may be part of a data platform, which is a system or suite of tools and technologies designed to communicate, manage, store, process, analyze, and/or visualize large volumes of data generated by the system 103. The data platform may be used by modern data-driven organizations, enabling them to harness the power of their data for various purposes, such as business intelligence, analytics, machine learning, and more. In general, the data platform includes components for data ingestion, data storage, data processing, data management, data integration, data analytics, machine learning (ML) and artificial intelligence (AI) platforms, data security, and the like. For example, a data ingestion component may use extract, transform, load (ETL) logic (tools or processes) that extract data from various sources, transform it into a suitable format, and load it into a storage system. The data ingestion component may be set up to stream real-time data from sources such as Internet of Things (IoT) devices, transactional systems, or other network functions. The data platform may include data storage components, such as data lakes, data warehouses, and database systems. Data lakes are large storage repositories that hold raw data in its native format until it is needed. Data warehouses are structured storage systems optimized for query performance and analytics, often storing cleaned and processed data. Database systems may include both relational (e.g., SQL) and non-relational (e.g., NoSQL) databases for various data storage needs. The data processing components may handle batch processing, streaming processing, or the like. Batch processing may handle large volumes of data in batches, typically for tasks like reporting, data transformation, and aggregation. Stream processing may handle real-time processing of continuous data streams to support applications like real-time analytics and monitoring. Data management components may handle metadata management and data governance. The metadata management may include tools for managing metadata, which is data about data, such as data catalogs, lineage, and governance. Data governance may involve policies and processes to ensure data quality, security, privacy, and compliance with regulations. Data integration components may provide application programming interfaces (APIs), data virtualization, and other capabilities. APIs may be used to access and integrate data across different systems. Data virtualization techniques may be used to abstract and integrate data from various sources without physically moving it. The data analytics components may include Business Intelligence (BI) and advanced analytics tools and platforms for data reporting, visualization, and dashboards to support decision-making. Advanced analytics techniques, such as data mining, predictive analytics, and statistical analysis, may be used to derive deeper insights. ML/AI platforms may provide a model training environment for developing and training machine learning models using data stored in the platform, as well as a model deployment environment for deploying trained models into production environments for real-time or batch inference. Data security components may provide access control, encryption, and other security measures. Access control mechanisms may ensure that only authorized users can access specific data. Encryption techniques may be used to protect data both at rest and in transit, preventing unauthorized access and breaches. The data platform may consolidate data from various sources into a single platform, making it easier to manage and access. The data platform may support large-scale data storage and processing, accommodating growing data volumes and increasing complexity. It may enable real-time data processing and analytics, allowing organizations to respond quickly to changing conditions. The data platform may facilitate collaboration across different departments and teams by providing a unified data environment. It may also implement data governance and quality control measures to ensure the accuracy and reliability of data. The data platform may provide the infrastructure, tools, and insights organizations need to manage, process, and analyze data effectively, enabling them to make informed decisions and unlock the full potential of their data assets. Additionally, the data platform may provide business intelligence and reporting capabilities. It may aggregate data from multiple sources to generate comprehensive reports and dashboards for business analysis. The data platform may offer real-time analytics, monitoring and analyzing data streams in real time to gain immediate insights and drive instant actions. It may provide customer insights by analyzing customer data to understand behavior patterns, preferences, and trends, thereby improving customer experience and loyalty. The data platform may also implement predictive maintenance, such as using machine learning models to predict equipment failures and schedule proactive maintenance in industries like manufacturing and utilities.

FIG. 2 is a block diagram of a system 200 implementing one or more message buses 202 within a cellular network according to at least one embodiment. FIG. 1 represents an embodiment of a cellular network that may facilitate real-time and non-real-time message bus data transmission in next-generation data transmission technologies. The cellular network 108 may be a next-generation cellular network configured for next-generation data transmissions. System 200 may include one or more message buses 202, one or more producers 204, one or more consumers 206, and a data store 208. The system may be configured as a 5G New Radio (NR) cellular network or other types of cellular networks, such as 6G, 7G, etc. In some embodiments, producers 204 may include UEs 104, RUs 112, DUs, CUs 118, and similar components. Consumers may include UEs 104, RUs 112, DUs 114, CUs 118, and systems and devices external to the cellular network 108. In some embodiments, the message bus 202 may be located either within the cellular network 108 (for example, as part of the message bus communication logic 102) or external to it.

The message bus 202 is a communication mechanism that facilitates the transfer of data from producers 204 to consumers 206. In some embodiments, the communication mechanism may be an existing wired connection between producers 204 and consumers 206. However, the RU 112 may not be directly hardwired to the CU 118. By using a message bus 202, there is no need for a hardwired connection between any one or more producers 204 and any one or more consumers 206. Utilizing the message bus 202 may eliminate the need for hardwired connections, which can introduce delays due to indirect routing. During the transmission of data through a message bus 202, the message bus 202 may be associated with one or more short-term data stores 214. The data may be temporarily stored within the short-term data stores 214 associated with the message bus 202 during transmission. The message bus 202 may then transmit the data from the short-term data stores 214 to the data store 208 or directly to the consumer 206.

Furthermore, by using message buses 202, data may be segmented and provided to select consumers 206 that can utilize the data, rather than passing all data through a single pathway. For example, passing a portion of data from the RU 112 to the DU 114 and another portion from the RU 112 to the CU 118 through the DU 114 may utilize the same pathways as the first portion of data. In some embodiments, only specific portions of data from one or more producers 204 may be provided to one or more consumers 206, depending on the consumers' data usage requirements. For example, consumer 206a may be configured to maintain a comprehensive and accurate record of the network's physical and logical components. In a complex system, consumer 206a may be dedicated to a certain aspect of the network. Therefore, consumer 206a may not require all data produced by the producers 204, or even all data from any one producer 204.

In some embodiments, the message bus 202 may be configured to receive and interpret requests for data transmission from the consumers 206. The requests may instruct the message bus 202 on the type of data that is expected, usable, and/or required by the consumer 206. For example, the requests may specify the type of data the consumer 206 needs and the producers 204 from which the data may be sourced. Additional identifiers may also be used by the message bus 202 to ensure the consumer 206 receives the desired data.

A type of data may include, but is not limited to, service configuration data, sensor data, network performance data, machine data, video and image data, geospatial and location data, telemetry data, event and log data, artificial intelligence and machine learning data, storage data, diagnostic data, control data, and so on. For example, if a consumer 206b is configured to use data to optimize network services, the consumer 206b may require topological data and service configuration data from data producers 204. Upon connection to the system 200, consumer 206b may provide standing requests to the message bus 202 to receive all topological data and service configuration data. In some embodiments, multiple consumers configured to optimize network services may be connected to the system 200 to optimize network services in different geographical areas. In such embodiments, the consumers may require data only from producers 204 in that geographical area. The requests provided to the message bus 202 may indicate the geographical area associated with the desired data, thereby enabling the message bus 202 to direct geographically appropriate data to the requested consumers 206.

In some embodiments, requests to the message bus 202 may occur when the consumer 206 determines a need for information. For example, if consumer 206a is configured to update records for producers 204, the records maintained at the consumer 206, at a designated period, consumer 206a may request updated data at that period. In some embodiments, the message bus 202 may provide the retrieval requests to all producers 204 within the system 200. In other embodiments, the message bus 202 may utilize one or more producer identifiers within the retrieval requests from the consumer 206 and provide the retrieval requests to one or more producers 204 associated with those identifiers.

In some embodiments, the consumer 206 may not be aware of the producers 204 connected to the system. In such embodiments, the consumer 206 may provide retrieval requests to obtain data of a certain type from the producers 204. The retrieval requests may be sent by the message bus 202 to all producers 204 indiscriminately to provide the information associated with the requested type. In some embodiments, the message bus 202 may provide the retrieval requests only to the producers 204 known to the message bus to generate data of the specified type.

In some embodiments, a producer 204 may generate multiple types of data, often through sub-producers 210. Sub-producers 210 may be components configured to capture specific types of data. For example, a sub-producer 210a may be a temperature sensor on the producer 204 that determines the operating temperature, while sub-producer 210b may be a geolocation component that determines the location data of the producer 204. In some embodiments, the sub-producers 210 may be configured to generate and provide data directly to the message bus 202. Alternatively, the sub-producers 210 may send data to a telemetry data framework 212 prior to providing the data to the message bus 202. The telemetry data framework 212 may collect, manage, and process telemetry data. The framework may receive raw data from the sub-producers 210, interpret and label it, and prepare it for use outside the producer 204. Each sub-producer 210 may be associated with a sub-producer identifier.

In some embodiments, the producer 204 may provide information to the message bus 202 during connection to the system 200. The producer 204 may indicate one or more data types produced, the amount of data produced, the presence of sub-producers 210, sub-producer identifiers, and other relevant information that the message bus 202 may be required to transmit to consumers 206. For example, if a sub-producer 210c, like sub-producer 210a, is a temperature sensor located at a different part of the producer 204, the message bus 202 may be required to keep temperature data separated based on the production source, rather than grouping all the data into a single data type, such as “temperature.” In some embodiments, the message bus 202 may use the predicted data amount provided to it to assign the output from a producer 204 (or a sub-producer 210 within the producer 204) to multiple message buses 202 to handle data transmissions efficiently.

In some embodiments, a producer 204 may be located in a specific geolocation that may be classified as a region. Different data analyses on regions may be required for diagnosing or otherwise monitoring the health and operation of a radio access network. To preserve regions and associated data, the producers 204 may include region identifiers as part of the data description.

In some embodiments, the message bus 202 may receive information from producers 204 and requests from consumers 206, and may determine which message buses 202 to use to connect the relevant producers to consumers that may utilize the data. The message buses 202 may act as non-permanent data transmission lines. Without needing to be provided to a large data store, the data may pass much more quickly to the consumer 206, enabling real-time data communication. Additionally, the lack of direct producer 204 to consumer 206 data communication lines may allow for flexibility and redundancy in data interpretation and consumption. Consumers 206 may be granted or denied access to producer 204 data as needed, without requiring changes to the physical components of system 200.

In some embodiments, the message buses 202 may provide data to the data store 208 for temporary storage if the data is not required immediately, or in a timely manner, by a consumer 206, but may be needed in the near future. In some embodiments, the data may be stored for a finite amount of time, such as three days. Such data store usage may enable non-real-time data communication alongside real-time data communication. The data provided to the data store 208 may be adjusted based on requests from consumers 206. For example, if a new consumer is initialized onto the system and requests a type of data that has previously been used sparingly and was directed to the data store 208 until specifically requested, the data may then be directed to the consumer 206, bypassing the data store 208 entirely. In some embodiments, an administrator or preset instructions may direct the message buses 202 on what data to provide to the data store 208, in addition to or instead of consumer requests.

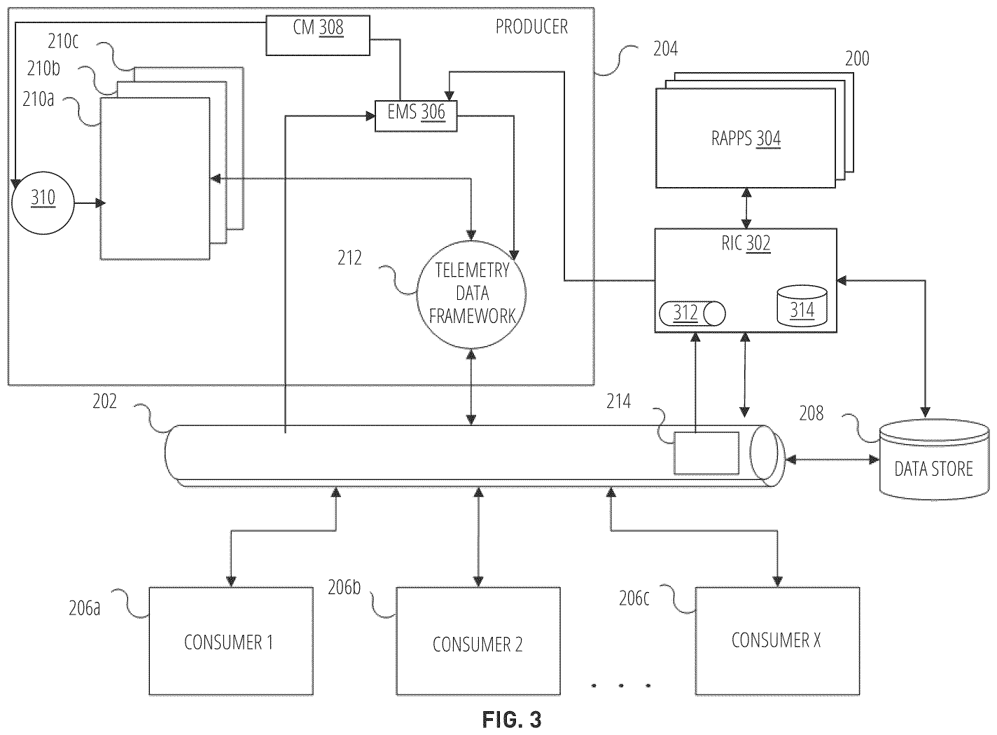

FIG. 3 illustrates a system 300 for implementing one or more message buses 202 within a next-generation cellular network 108 (e.g., 5G NR, 6G, 7G). The system 300 may support both real-time and non-real-time data transmission using a decoupled architecture. System 300 comprises one or more message buses 202, a plurality of producers 204, a plurality of consumers 206, and a data store 208. The message bus 202 serves as a communication layer that decouples producers 204 from consumers 206.

The producers 204 may be data-generating network components distributed across various layers of the telecommunication network, such as UEs 104, RUs 112, DUs 114, and CUs 118. Each producer 204 may be associated with one or more sub-producers 210, which provide localized telemetry data. For example, a sub-producer 210 may be a temperature sensor embedded within an RU 112. If the temperature at that RU exceeds a predefined threshold, the telemetry data framework 212 may detect and classify this event as an anomaly. The telemetry data may be transmitted via the message bus 202 directly to consumers 206 for immediate action or may be persisted in the data store 208 for later analysis, depending on the urgency and type of the event.

Because each sub-producer 210 provides only localized insight, aggregated telemetry may be used to derive a network-level understanding of operational conditions. A RAN Intelligent Controller (RIC 302) may be deployed within the system. The RIC 302 may be implemented as a centralized or distributed controller and may coordinate with both producers 204 and sub-producers 210 to support near-real-time and non-real-time control functions. Near-real-time operations may include scheduling, beamforming, or interference mitigation, while non-real-time operations may encompass policy enforcement, energy efficiency optimization, and AI/ML-driven network planning.

The RIC 302 may ingest telemetry data from the message bus 202 or the data store 208 and apply policy-based decision logic to optimize RAN behavior. The RIC 302 may include or access a message bus 312 for asynchronous communication between modular applications and a local data store 314 for caching telemetry data and analytics outputs. The RIC 302 may expose the data to one or more modular applications known as xApps and rApps 304. These applications may handle tasks such as managing radio resources, optimizing network performance, detecting anomalies, and ensuring service quality. Each rApp 304 or xApp may operate independently or collaborate with other applications.

Telemetry data aggregated by the RIC 302 may be used by rApps 304 to analyze real-time or historical performance metrics. Control of these applications might involve setting operational parameters, delivering policy updates, or managing event triggers that define when and how the apps may respond. The parameters may be supplied to the RIC 302 based on the components of the system or the desired operating states of the system. The policies may be learned by the RIC 302, for example, using machine learning techniques, or may be received according to system standards. The RIC 302 may initiate the rApp and the xApp or determine a condition that causes initiation. For instance, the RIC 302 could continuously stream traffic load and mobility data to an xApp responsible for managing handovers, while simultaneously providing a historical dataset and long-term policy objectives to an rApp focused on optimizing mobility strategies over time. The RIC 302 may also coordinate the interaction between applications. These apps may employ rule-based systems, statistical inference, or machine learning models to detect trends, predict faults, or generate control recommendations. For example, if telemetry indicates thermal anomalies at a specific RU 112, a thermal management rApp 304 may be invoked to determine corrective actions. The rApp may recommend reducing transmission power, adjusting scheduling policies, or activating auxiliary cooling functions. These recommendations may be communicated to the Element Management System (EMS 306), the Configuration Manager (CM 308), or directly to affected producers 204 via the CI/CD framework 310.

The RIC 302 may utilize authentication and authorization for all xApps/rApps and external controllers, leveraging certificate-based mutual authentication and role-based access control. All telemetry data may be encrypted in transit and at rest using industry-standard protocols.

The EMS 306 may serve as a coordination point for applying network-wide or localized control actions. It may receive recommendations or control instructions from rApps 304 and respond by initiating configuration changes or modifying telemetry collection parameters via the telemetry data framework 212. The EMS 306 may also instruct the CM 308 to execute the recommended updates, ensuring consistency with operational policies.

The CM 308 may function as a control point for managing device-level configurations and firmware across the network. Operating in conjunction with the Continuous Integration/Continuous Deployment (CI/CD) framework 310, the CM 308 may receive validated configuration changes or update artifacts from the EMS 306 or directly from the RIC 302. These updates may include parameter adjustments, control logic updates, or firmware patches. The CM 308 may evaluate the target scope based on metadata (e.g., device type, health state, location), package the changes into configuration artifacts, and coordinate their delivery through secure management interfaces.

The CI/CD framework 310 may propagate updates across the distributed network. Integrated with the CM 308, the CI/CD framework 310 may perform artifact versioning, validation, and rollout orchestration, ensuring updates are deployed reliably and in accordance with operational policies. The CI/CD framework 310 may maintain version control of all configuration artifacts. Validation of each artifact for correctness and policy compliance may be performed prior to implementation. The CI/CD framework 310 may schedule updates to minimize service disruption, for example, during a rollout. For instance, if a thermal management rApp 304 recommends reducing the transmission power on a particular RU 112, the CM 308 may encode this change into a configuration artifact, which the CI/CD framework 310 then deploys to the relevant sub-producer 210.

The deployment may be monitored in real time, with rollback mechanisms triggered if anomalies are detected post-deployment. Telemetry data from the deployment may be compared with criteria associated with the intended change. These criteria may be related to allowable operating thresholds. Upon satisfaction of those thresholds, the telemetry data may indicate that the operating states need to be adjusted again if the components are not operating within proper conditions. For example, if the transmission power is reduced to lower the temperature, the criteria may indicate either allowable transmission power, to determine that the power is not improperly adjusted, allowable temperatures, to monitor the effects of the change, or other parameters associated with components that may be affected by changes in transmission power.

In certain scenarios, the system 300 may utilize fault management procedures. For instance, if the EMS 306 detects a persistent anomaly or failure pattern, it may activate additional rApps 304 to conduct diagnostics, perform predictive maintenance, or recommend traffic re-routing. The RIC 302 may dynamically reallocate traffic flows away from the impacted RU, while the CM 308, in coordination with the CI/CD framework 310, may push additional configuration changes to stabilize or isolate the faulty component.

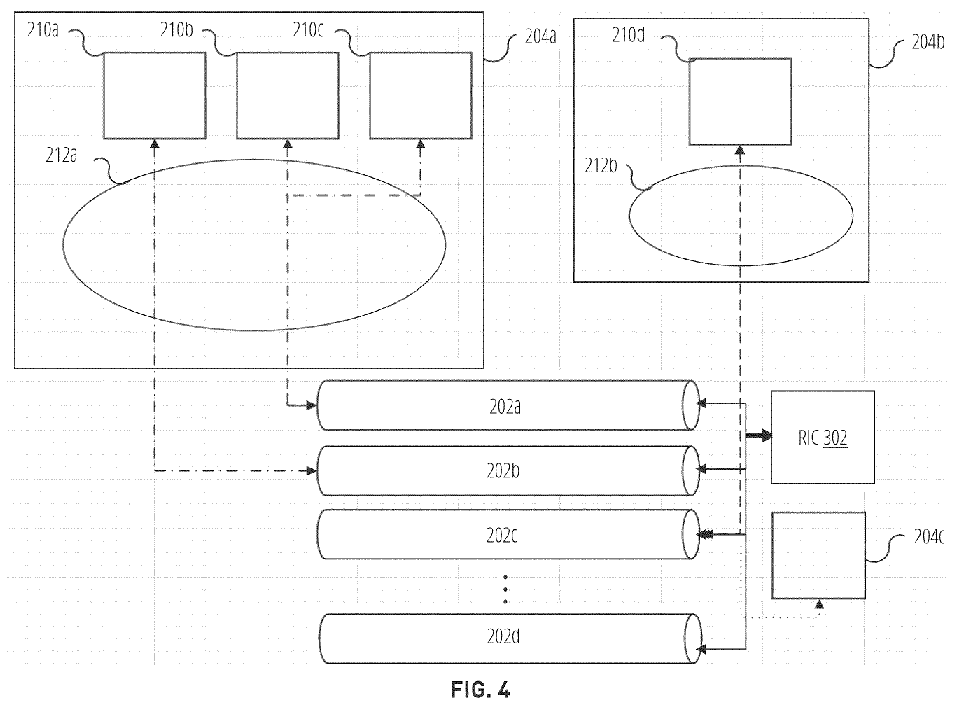

FIG. 4 shows a first producer 204a with three sub-producers 210a-210c. The sub-producers 210a-210c are configured as Open Radio Access Network (O-RAN) components, such as the RUs 112, DUs 114, and CU 118 of FIG. 1. O-RAN components may include architectures and/or elements disaggregated across a radio access network that enable the functionality of one or more edge devices within a telecommunication system. For example, O-RAN components may interact with and be hosted in distribution centers, including but not limited to a RAN distributed center (RDC), a local distributed center (LDC), a backhaul edge distributed center (BEDC), and/or a public edge distributed center (PEDC). The RDC, LDC, BEDC, and PEDC may represent different levels of abstraction between edge devices. For instance, the RDC may be deployed closer to an edge device without direct interaction, while an LDC may interact directly with an edge device. As described herein, O-RAN components stored in the edge distribution centers may act as producers or consumers; therefore, edge devices may be referred to as “producers” or “consumers” based on the components they contain.

To coordinate and optimize operations across these distributed and dis aggregated O-RAN components, the RIC 302 may be implemented as a centralized or distributed entity, communicating with components at the RDC, LDC, BEDC, and PEDC levels, and orchestrating actions through specialized applications (rApps and xApps) to optimize overall RAN behavior.

Specifically, data from the RUs 112, DUs 114, and CUs 118 may supply input to the RIC 302. For instance, the RU 112 may generate low-level radio frequency measurements, which may be used by the RIC 302 to adjust radio parameters such as antenna configurations. The DU 114 may contribute real-time processing data, such as user plane throughput and scheduling effectiveness, which may be utilized by the RIC 302 for resource allocation and traffic management decisions. The CU 118 may provide higher-layer control information, including mobility management and session handling, which may be utilized by the RIC 302 to coordinate handovers and optimize overall network policies.

In O-RAN architecture, RU 112, DU 114, and CU 118 may be designed to be disaggregated and modular, providing flexibility and scalability across the network. These components are closely integrated with various network deployment models such as LDC, RDC, BEDC, PEDC, and others, which support physical and virtual network functions efficiently. The LDC is located near the network edge and may host the DU, which is responsible for real-time processing tasks such as radio signal transmission, user plane management, and lower-layer processing. By placing the DU 114 in the LDC, O-RAN ensures that latency-sensitive operations, such as user data handling, are performed closer to end users, minimizing delays and improving the overall quality of service for applications like mobile broadband.

The RIC 302 may utilize the low-latency data production of the DU 114 in the LDC rather than the higher-latency data production of edge devices farther away from end users. The RIC 302 may utilize the data from the DU 1140 adjust scheduling algorithms, enabling more efficient use of radio resources and an improved user experience. Similarly, data collected at the RDC and BEDC levels may provide the RIC 302 with a broader perspective on network load and performance trends, allowing for higher-level control decisions that influence multiple DUs 114.

In contrast, the RDC is typically located farther away from the edge, serving as a centralized location for the CU 118. The CU 118 handles higher-layer functions such as scheduling, mobility management, and radio resource management, which require coordination across multiple DUs 114 and are less time-sensitive than tasks performed by the DU 114. The RDC provides the necessary computing resources to manage these tasks on a larger scale, allowing for more centralized control while still maintaining network flexibility and scalability. The CU 118 in the RDC is connected to the DU 114 in the LDC through high-speed, low-latency links, ensuring seamless communication between the disaggregated components.

The BEDC may be responsible for hosting the baseband processing functions that are part of the DU 114 and CU 118. The BEDC is often deployed in a more centralized location, as it supports the aggregation of multiple DUs and provides centralized control and processing for resource management and coordination across a large geographical area. The BEDC ensures that higher-layer processing, such as scheduling, mobility management, and user plane functions, is handled efficiently, often in coordination with the CU 118, which may be located in an RDC. By deploying baseband processing functions in the BEDC, operators can streamline operations and provide network-wide management of traffic and resources without having to deploy baseband equipment directly at each cell site.

In contrast, the PEDC is located closer to the network edge, typically in proximity to the users. The PEDC may host the DU 114 and supports low-latency, real-time operations required for tasks such as radio resource management, real-time traffic handling, and user plane processing. Placing the DU 114 in the PEDC ensures that latency-sensitive operations, such as voice calls, video streaming, and interactive applications, are processed as close to the user as possible, minimizing delays and improving the user experience. The PEDC may also serve as an aggregation point for multiple cell sites, providing the necessary resources for managing traffic across a larger area while still maintaining low latency for edge applications.

O-RAN components may be components that produce data within next-generation data communication systems (e.g., 5G, 6G, and the like). O-RAN components allow functionalities within a telecommunication system to be executed using multiple vendors. For example, the first sub-producer 210a may receive data provided by a first vendor, while the second and third sub-producers 210b-210c may receive data provided by a second vendor. The first and second vendors may produce overlapping data and, in some embodiments, may have varied scopes of data production and capture. Using a multi-vendor ecosystem, the producer 204 may generate more data than would be possible in a single-vendor ecosystem.

Furthermore, data production in producers that utilize O-RAN components may include components at multiple levels of hierarchy (e.g., at the RDC, LDC, BEDC, PEDC, and the like). In some embodiments, data is produced at each level of the hierarchy. The data may be redundant between levels or may pertain to the specifics of each level, thereby creating more data than non-O-RAN systems. For example, producer 204a may be one or more edge devices that utilize O-RAN producers 210a-210c at various levels of hierarchy. Such additional data production could overwhelm a central data store or may require a high-capacity data store or multiple data stores. Accommodations in a central data store may be costly in both storage space and operating costs. In embodiments where the sub-producers 210 are O-RAN components, such as in producer 1 204a, the telemetry data framework 212a may be used to accept data from multiple levels of abstraction generated by multiple vendors and normalize the data into an expected output format.

The RIC 302 may receive data directly from producers 204 or may only receive data once it has been normalized by the telemetry data framework 212a. Using consistently formatted data, the xApps and rAPPs 304 can utilize data from multiple vendors and sources for comprehensive analysis.

Decentralization of the O-RAN components results in the generation of a wide variety of data that is critical for analyzing the health and operation of the telecom network. These data types may be used to monitor network performance, optimize operations, and predict potential issues. Performance metrics such as received signal strength, signal-to-noise ratio, reference signal received power, and reference signal received quality may be used to determine the health and efficacy of components within the system. These performance indicators are essential for diagnosing coverage issues, interference, or areas where signal strength is insufficient, thus helping network operators optimize network placement and improve user experience in challenging environments.

Traffic and throughput data may be used to track the volume of data being transmitted and received across the network. This includes metrics such as downlink and uplink throughput, packet data traffic, and data volume per user. Such data is essential for monitoring network congestion and capacity, ensuring that the network can handle increasing data demand, especially during peak usage times. Analyzing traffic data helps operators identify congestion points, underutilized resources, and areas that may require network upgrades, as well as plan for optimal resource allocation and traffic management.

The telemetry data may enable the RIC 302, using machine learning models and rule-based engines, to detect anomalies, predict network degradation, and trigger automated remediation actions. For example, if the RIC identifies a sudden drop in signal quality in a certain area (from RU or DU data), the RIC 302 may cause parameter adjustments to maintain service quality.

Quality of Service (QoS) metrics are also crucial for assessing network health, particularly for latency-sensitive applications. Data on latency, including round-trip time (RTT), packet loss, and jitter, is used to measure the responsiveness and reliability of the network. High latency or jitter may significantly affect user experience, especially for real-time applications like video conferencing or VoIP. Tracking QoS metrics enables operators to maintain network performance by addressing issues that may affect critical applications and ensuring that latency-sensitive services receive appropriate priority.

Fault and alarm data are other critical sources for analyzing network health. These alarms indicate when network elements, such as the RU 112, DU 114, or CU 118, experience operational failures or degraded performance. Alarm data may include information about hardware malfunctions, link failures between RAN components, or service interruptions that affect the quality of the user experience.

Mobility and handover data provide valuable insights into how users are moving across the network and how well the network is handling handovers between cells. Metrics such as handover success rate, handover failure reasons, and cell reselection data help operators understand the performance of mobility management and the ability of the network to seamlessly support users as they move between different coverage areas. Analyzing mobility data aids in optimizing handover processes, preventing service interruptions, and ensuring that users receive a smooth experience when transitioning between cells, particularly in high-traffic or dense urban environments.

In some embodiments, for example, when O-RAN sub-producers 210a-210c are producing more data than can be handled by a message bus 202 of a certain size, the system 200 may allocate multiple message buses.

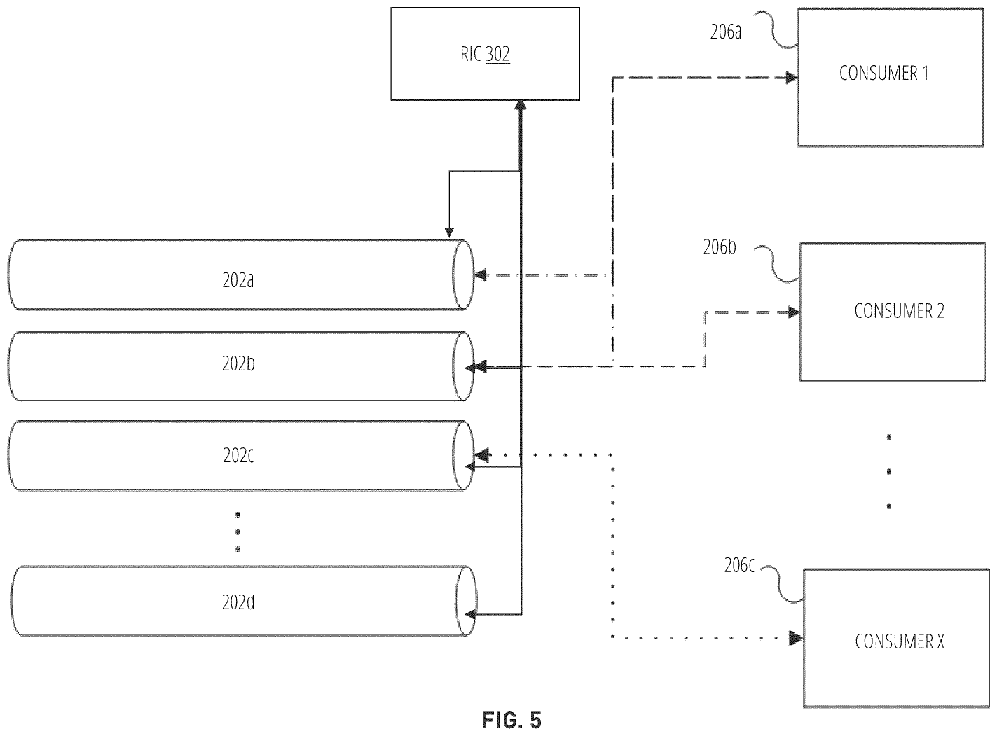

FIG. 5 shows one or more consumers 206 utilizing one or more message buses 202 within the system 103 according to at least one embodiment. As described in FIG. 1, in some embodiments, the system 200 may utilize one or more message buses 202 to connect to consumers 206 within the system 200. In some embodiments, a connection between a consumer 206 and a message bus 202 is determined based on the data required and/or requested by the consumer 206. In some embodiments, upon configuration of a consumer 206 within the system 200, the consumer provides retrieval requests to the system 200 to allow the system to connect the consumer 206 to the message bus 202 that can transmit the requested data from a producer 204. For example, a consumer 206 may be configured as an orchestration platform for a slice of a data communication system. An orchestration platform may, in some embodiments, use data associated with the slice, such as according to a geographic region, to automate service provisioning and network performance management. The data required may include operational data from multiple components within the producer 204. The retrieval request, as part of the configuration of the consumer 206, may provide the geolocation associated with the slice so that the message buses 202 in data communication with the consumer 206 may receive data from producers 204 associated with the geolocation.

In some embodiments, a request for integration into the system 200 may be fielded by a user of the system 200, who may manually assign the producers 204 and consumers 206 to message buses 202. In other embodiments, based on the configuration information provided by the consumer 206 and/or the producer 204, the message buses 202 may be assigned automatically by the system 200, for example, at a central controller. More discussion on a central controller may be found in the discussion of FIG. 5 below.

FIG. 5 shows a first consumer 206a receiving data from a first message bus 202a and a second message bus 202b. As described in FIG. 3, data from a single producer 204a may be transmitted using multiple message buses 202a and 202b. Consumer 1 206a may be a consumer that requires all of the data from a single producer 204a. In some embodiments, Consumer 1 206a may require only a portion of the data provided by each message bus 202a and 202b. Thus, the consumer 206a is connected to the message buses 202a and 202b that connect with the producer 204a. Consumer 2 206b may not require all the data produced by producer 1 204a, but rather may only require the data produced at the O-RAN sub-producer 210a. Thus, producer 2 is not connected to any message bus 202 other than message bus 2 202b.

The RIC 302 may connect to a message bus 202 and act as a consumer 206 within the system 200. As a consumer, the RIC 302 may request and receive telemetry data and operational metrics from message buses 202 that aggregate data from multiple producers 204 and their associated O-RAN components. The RIC 302 may consume data in various ways, collecting information based on the current needs of xApps or rApps, which require different subsets of data. For example, a first rApp may only periodically perform computational analysis, so data for the first rApp may only be requested by the RIC 302 at those times. A second rApp may conduct consistent reviews but on data from different sources than the first rApp. Based on these varying needs, the RIC 302 may obtain different data from the message bus 202 at different times. The RIC 302 may also connect to multiple message buses simultaneously to gather a comprehensive set of data across different network layers and geographical locations.

The RIC 302 may operate as multiple, decentralized RICs 302 throughout the telecommunication network 200. Each RIC 302 may connect to one or more message buses 202 to retrieve different subsets of telemetry and operational data based on their distinct control functions or geographic domains. For instance, one RIC may consume data focused on radio resource management from RUs and DUs in a specific region, while another RIC may target mobility management and scheduling data from CUs in a different area. This decentralized RIC architecture enables distributed decision-making, where each RIC analyzes the data relevant to its scope and coordinates with other RICs to share insights or control commands, thereby enhancing network-wide optimization.

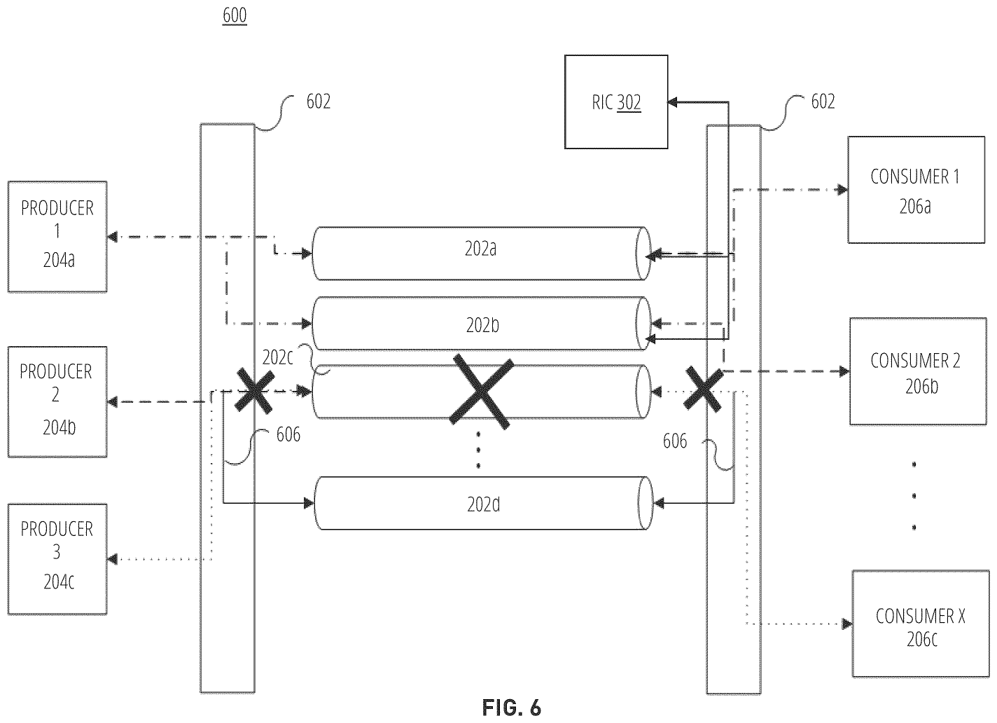

FIG. 6 shows central controller 602 utilized for smart connection of one or more producers 204 to one or more consumers 206, according to at least one embodiment. The central controller 602 is depicted as two distinct pieces but may instead be a single central controller capable of accessing and configuring connections between message buses 202, producers 204, and consumers 206. As mentioned above, the central controller 602 may be stored within the message bus communication logic 102 and may be used to automatically configure traffic to and from the message buses 202 of the system 200. In some embodiments, the central controller 602 accepts configuration requests from both producers 204 and consumers 206 and assigns them to message buses 202 as described above. In some embodiments, the central controller 602 may also manage faults within the system 200. In some embodiments, the central controller 602 may include a processing unit and a memory storing one or more executable instructions that cause the central controller 602 to enable communication channels between producers 204, consumers 206, and message buses 202.

As shown in FIG. 2 and FIG. 5, a first producer 204a may be configured by the central controller 602 to provide data to message buses 202a and 202b, while a second producer 204b and a third producer 204c may be configured to provide data to message bus 202c. Similarly, the central controller 602 may configure Consumer 1 206a to retrieve data from message buses 202a and 202b, Consumer 2 206b from message bus 202b, and a third consumer 206c from message bus 202c.

In some embodiments, one or more RICs 302 may act as consumers 206. The central controller 602 may configure each RIC 302 to connect to specific message buses based on the RIC's functional role and geographic domain. The central controller 602 may configure connections between the RICs 302 and the message buses 202 based on data requirements.

In some embodiments, after configuring the system 600, the central controller 602 may remain inactive until a subsequent configuration request to add a producer 204 and/or a consumer 206 is provided to the system 600. At that time, the central controller 602 may identify and provision proper access through message buses 202 for the newly configured component.

In some embodiments, the central controller 602 may monitor and mitigate connection faults within the system 600. Monitoring and mitigation may include the central controller 602 reviewing logging systems that track the health and performance of network connectivity, brokers, message delivery, and system resources. Additionally, the central controller 602 may utilize alerting mechanisms and heartbeat checks to help identify issues such as message loss, duplication, timeouts, and resource exhaustion in real time.

In a message bus system, various faults may arise, affecting its reliability and performance. Network connectivity failures can disrupt message delivery due to issues such as packet loss or intermittent connections between nodes. Broker failures, such as crashes or unresponsiveness, may halt message processing and impact communication between producers and consumers. Message loss may occur if messages are dropped during transmission or are not properly acknowledged. Message duplication can result when a message is delivered multiple times, leading to redundant processing by consumers. Data corruption may affect message integrity during transmission or storage, causing incorrect data delivery. Queue overflows or underflows may occur when message queues exceed capacity or are underutilized, disrupting the flow of messages. Timeouts and latency issues may delay message delivery, causing operational disruptions. Authorization and authentication failures may prevent proper access control, leading to rejected connections or messages. Configuration errors may result from improper settings that misroute messages or prevent successful processing. Resource exhaustion, such as running out of memory or disk space, may cause the system to fail to process messages. Topic or queue saturation may occur when a particular topic or queue becomes overloaded, hindering message distribution. Finally, broker synchronization issues may lead to data inconsistencies across distributed brokers, disrupting message processing.

As shown, for example, message bus 202c may have experienced a fault preventing transmission of all data that was being provided by the producers 204b and 204c to consumer 206c. In some embodiments, upon detecting the fault, the central controller 602 may alter communication pathways to reestablish the connection. As shown, the producers 204b and 204c are rerouted 606 to provide data to message bus X 202d. In some embodiments, the central controller 602 selects a message bus to reroute the communication pathway based on the available transmission capacity of message buses in the system. The available transmission capacity may be compared with the transmission throughput of the original message bus to ensure the new message bus can support the required throughput.

To retrieve the data, the third consumer 206c is rerouted 504 to message bus 202d (e.g., a replacement message bus) to receive the data. To enable the connection, the central controller 602 may utilize existing message buses that may already be connecting producers and consumers, or may provision and/or utilize an additional message bus. Utilizing existing message buses may include providing requests to the producer and consumer to connect to the alternate message bus for data that was previously transmitted through the faulty message bus. To connect a data producer or consumer to a message bus, the system may be configured with appropriate network connectivity and credentials to authenticate and authorize access. Additionally, the producer or consumer may implement the correct message protocols and serialization formats supported by the message bus for proper message formatting and communication. In some embodiments, the central controller 602 may be required to generate a new message bus and redeploy the message bus and/or connections to the producer and consumer.

In some embodiments, multiple RICs 302 may be operating as decentralized consumers across the system. The central controller 602 may manage the configuration of each RIC 302 independently. For example, if a message bus used by a near-RT RIC fails, the central controller 602 may reroute only that RIC 302 to a new message bus that enables continuity of real-time control. Meanwhile, a non-RT RIC that aggregates long-term network analytics may be routed through a different recovery path or temporarily paused without disrupting critical operations.

In some embodiments, while reestablishing a connection to the producer, the central controller may provide the data from producers 204b and 204c to a data store to be maintained until the consumer is ready to receive data through a message bus. In some embodiments, the central controller may utilize artificial intelligence and/or machine learning to predict data production by producers to better allocate message bus capabilities. For example, if a producer does not produce as much data as initially predicted, the central controller may add additional producers to a previously dedicated message bus.

In some embodiments, the central controller 602 is configured to receive configuration requests from the producers 204 or the consumers 206. The central controller 602 may utilize protocols to authenticate the source of the request as a valid entity. In some embodiments, a request may be input into the system 600 using a web-based application that requires log-in credentials from the user device. The central controller 602 may use these log-in credentials and authentication data logs to verify the validity of the request. In some embodiments, the central controller 602 may initiate handshake protocols, token generation, session-based authentication, mutual authentication via pre-shared keys, public key infrastructures, and similar methods to authenticate the request. More specifically, network connectivity may be established using TCP/IP or other communication protocols, enabling the producer and/or consumer to connect to the message bus over the network. Authentication and authorization may be handled through mechanisms such as API keys, OAuth, or certificates, ensuring that only authorized entities can publish or consume messages. Message protocols may define the structure of the data exchanged, while serialization and deserialization processes ensure that the data is correctly formatted and interpretable by both the producer and consumer.

In some embodiments, following the receipt of the request, the central controller 602 may parse the request for relevant data to configure the connection. In some embodiments, as described below, the request may be made via a web-based application, providing the request to the central controller 602 in an expected format. In some embodiments, the request may be provided in a different format, requiring the central controller 602 to identify the relevant information within the request. In some embodiments, parsing the request may include utilizing machine learning, such as large language models, to analyze the request. For example, a large language model (LLM) may parse a request by first tokenizing the input text into smaller units (tokens) to understand its structure. It may then apply deep learning algorithms to map the tokens to their semantic meaning, recognizing intent, entities, and relationships. The LLM may convert the mapped tokens into a standardized form, ensuring consistent interpretation regardless of variations in phrasing or syntax. In some embodiments, the central controller 602 may request additional information from the request source. In some embodiments, the request may include producer 204 and/or consumer 206 specifications, expected output/input requirements, data types, and similar details.

In some embodiments, the central controller 602 may maintain a mapping of the message bus 202 connections, message bus 202 capacities, and message bus 202 availabilities. The mapping may be stored in a local data storage for the central controller 602 or in the data store 208 as illustrated in FIG. 2. After parsing the request, the central controller 602 may determine a proper configuration and connection with one or more message buses 202 and may update the mapping accordingly. The central controller 602 may then facilitate the connection from the producer 204 and/or consumer 206 to the message buses 202.

In some embodiments, producers 204 may be fully manageable, partially manageable, or non-manageable by the central controller 602. Manageability may be characterized by the ability of the central controller 602 to change aspects or connections of the producer 204 without input from additional components or users. For example, a fully manageable producer 204 may be one for which system administrators have sole control. Partially manageable producers 204 may be those to which the central controller 602 has limited access but can adjust in some manner. A partially manageable producer 204 may be configurable by the central controller 602 such that the central controller 602 can reroute a connection from a first message bus 202 to a second, potentially new message bus 202 without input from a producer administrator, or with only limited permissions required from a producer administrator. In some embodiments, a non-manageable producer 204 may be one that is completely managed by an external source, such as an external administrator or vendor. In such embodiments, the central controller 602, upon detecting a fault, may provide instructions to the producer 204 to reroute a connection to a secondary message bus 202 but may not complete the rerouting itself. In some embodiments, rerouting connections to a secondary message bus may require the central controller 602 to generate a new deployment that may enable a connection to a non-manageable producer 204. In such embodiments, the central controller 602 may generate the deployment and provide the deployment, or connections to the deployment, to the producer 204 for instantiation.

Similarly, consumers 206 may be fully manageable, partially manageable, or non-manageable by the central controller 602. As with producers 204, a fully managed consumer is one for which the system has complete control. A partially managed consumer 206 is one that the system has limited ability to configure and may or may not require permission from an administrator of the consumer 206 to connect to a secondary message bus. A non-manageable consumer 206 is one that is entirely under the control of a secondary administrator, such as a vendor, and any adjustments to the connections to the message bus 202 must be completed by the administrator of the consumer 206.

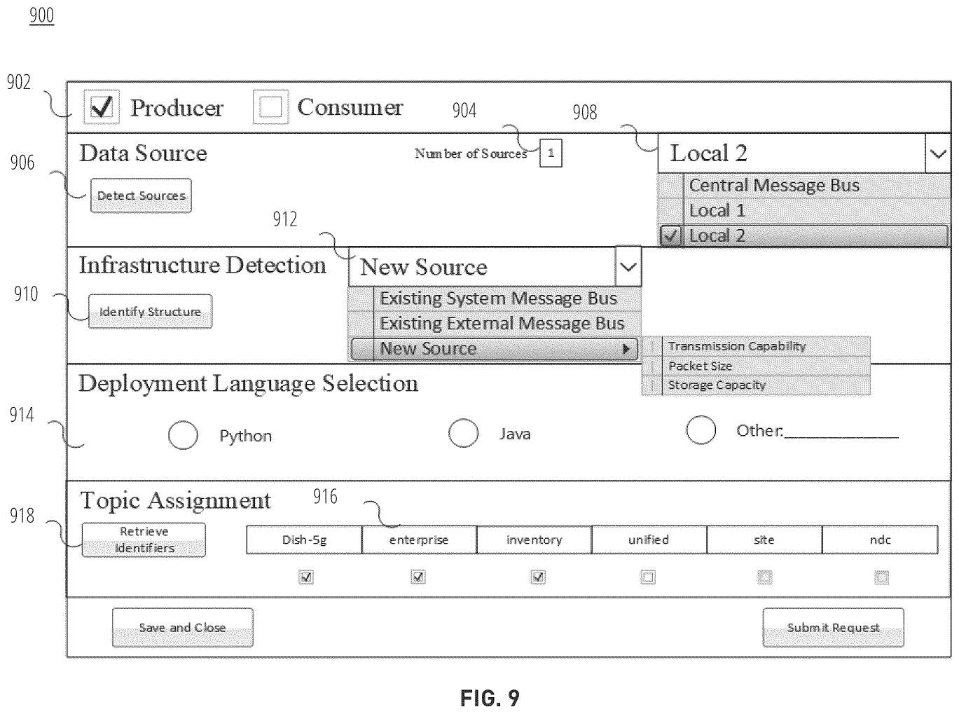

As described later in FIG. 9 to FIG. 11, removing a connection to a first message bus 202c and rerouting connections between a producer 204 and a consumer 206 to a secondary message bus 202d may require a deployment of instructions and/or message buses based on the characteristics of the clients. Further description of generating deployments may be found in those figures.

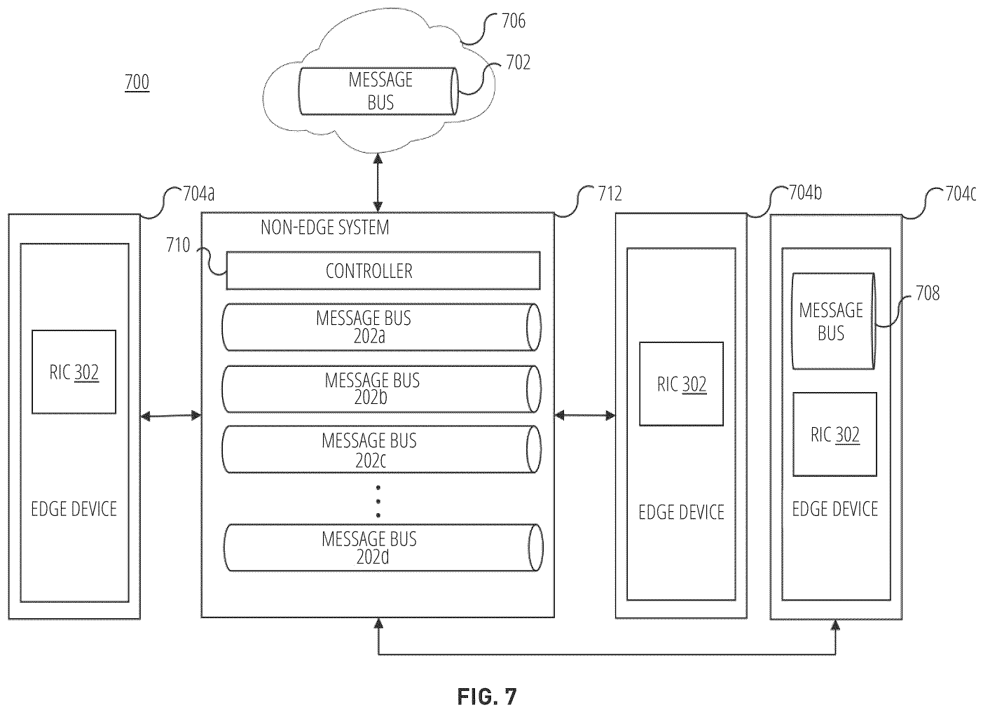

FIG. 7 shows message buses 202 within a non-edge system 712, a message bus 708 at an edge device (e.g., edge distribution center) 704, and a message bus 702 in cloud storage 706, according to at least one embodiment. As described above, the edge devices 704 may communicate with or store O-RAN components such as RUs 112 and DUs 114. In some embodiments, message buses 202, 702, and 708 may be deployed throughout a telecommunication system 700. The telecommunication system 700 may include connections for the non-edge system that exists in hierarchical layers above the edge devices, as described in FIG. 4, and that connect to multiple edge devices 704 and cloud computing environments 706. As described above, producers 204 and consumers 206 may provide or receive data within the system 700 using message buses 202, 702, and 708. The message buses 202 may be on the hierarchical layers of the non-edge system 712 within the telecommunication system 700.

In some embodiments, the edge devices 704 may be producers 204 and/or consumers 206. In some embodiments, edge devices 704 may be used to optimize network performance of a telecommunication system 700. Edge devices 704 may be positioned at the edge of the telecommunication system 700, close to end users, to help process, store, and route data without requiring communication back to the non-edge system 712 or a central system. Edge devices 704 may generate data, consume data, and store message buses 708 to supply data from producers 204 to consumers 206. The edge devices 704 may include equipment and systems that serve as a central hub for the delivery and distribution of telecommunication services to end users. Edge devices 704 may include equipment such as racks, servers, power supplies, signal processors, telecom service equipment, modulators, environmental control systems, and the like. In some embodiments, the edge devices 704 may include one or more O-RAN components generating data as described in FIG. 1. The O-RAN components may be normalized by a telemetry data framework and provided through message buses 202 to consumers.

In some embodiments, the edge devices 704 may host one or more RICs 302, either near-real-time (near-RT RICs) or non-real-time (non-RT RICs), that act as consumers 206 for locally generated or regional network data. For example, a near-RT RIC operating on the edge may consume radio performance metrics or mobility management data directly from RU/DU components through the message bus 708, enabling sub-second response decisions without needing to route through a central controller.

In some embodiments, the edge devices 704 may produce data related to any of the systems and equipment within the edge device 704, including O-RAN and non-O-RAN components. In some embodiments, edge devices 704 may generate network performance data, user data, device and IoT data, traffic management and routing data, security and threat data, content and application data, base station data for mobile networks, edge device health and monitoring data, and the like. In some embodiments, consumers 206 may utilize some or all of the generated data from an edge device 704 and may process the data for different uses.

In some embodiments, the data may indicate time-sensitive issues, such as network blackouts identified by performance data showing packet loss. In these cases, it is beneficial to have a message bus 708 on the edge device 704c, enabling direct and rapid data transmission from the edge device to the consumer 206, bypassing the non-edge system 712. In some embodiments, a near-RT RIC acting as a consumer may be deployed on the same edge device 704c, enabling ultra-low-latency control feedback loops that do not require communication with centralized components. In some embodiments, the edge device 704 may act as a consumer 206.

In some embodiments, message buses 202 may be located at a non-edge system 712, such as a central hub for one or more edge devices, and/or a message bus 708 may be deployed locally at an edge device 704c. A message bus 708 at an edge device may provide faster data communication. For example, an edge device 704c may provide data that is used by two or more O-RAN components within the edge device 704c on two or more separate hierarchy levels, as well as by a third-party consumer. By deploying the message bus 708 directly on the edge device 704, the O-RAN components may receive the data directly without the data passing through additional components at the non-edge system 712.

In some embodiments, decentralized RICs 302 deployed across multiple edge devices may coordinate as a logical RIC framework, where each RIC 302 acts as an independent consumer but shares policy or insights via distributed message buses (e.g., message bus 708 at each edge device). Each RIC 302 may subscribe to edge-specific topics and may provide telemetry summaries or optimization outputs to shared message buses at the non-edge system 712 or to a cloud message bus 702.

Depending on the type of data being collected and consumed, the telecommunication system 700 may benefit from the lower latency provided by a message bus 708 at an edge device 704c, or it may use a message bus 202 located in the non-edge system 712. For example, an edge device 704a may produce data that indicates high network traffic at the edge device 704. High network traffic may be an issue that needs to be addressed but may not be time-sensitive. The edge device 704a and the edge device 704b may provide network traffic data to a consumer 206 through a message bus 202 at the non-edge system 712. The consumer 206 may determine that a second edge device 704b is experiencing much lower network traffic than the first edge device 704a, such that the second edge device 704b could accept additional network traffic loads. The consumer 206 may utilize the data from the first and second edge devices 704a-b to determine if the network traffic needs to be reallocated or if an additional edge device 704 is required, and where, geographically, it may be added.

In some embodiments, the third-party consumer may receive the data from the message bus 708 deployed on the edge device 704c, or the data for the third-party may be provided through a message bus 202 within the non-edge system 712. While the data may take longer to be delivered to the third-party, a central message bus 202 may serve as an access point that connects multiple edge devices 704 with the third-party, allowing the third-party to maintain a single access point. In some embodiments, the system may utilize the central message buses 202 to protect the edge device 704c by abstracting access by third parties.

The message bus 702 may be stored in a cloud computing environment that is remote from and/or external to the telecommunication system 700. In some embodiments, the cloud computing environment 706 may be owned and maintained by a third party. By utilizing a message bus 702 on a cloud storage system 706, the consumer access point may be further abstracted from the telecommunication system 700, protecting the system from external interference. In some embodiments, cloud storage may allow for increased message bus 702 capacity and increased accessibility across devices and locations, particularly for remote access and similar use cases.

In some embodiments, the message bus 702 in the cloud computing environment 706 may serve as the communication pathway between a producer 204 and a consumer 206. After this assignment, the system 700 may send requests that allow the producer and/or consumer to send or receive data via the cloud-based message bus 702. The requests may be provided by the controller 710 and may include identifying information for the producer 204 and/or the consumer 206 to enable data communication. In some embodiments, controller 710 may be the same as or different from the central controller 602 in FIG. 5. Identifying information within the requests may include, but is not limited to, the bus address (including an IP address of the message bus), port number, authentication and authorization information, connection settings and protocol details, message bus topic, and the like. Information may be added or prevented based on the information that is required to establish the connection.

In some embodiments, the controller 710 of the non-edge system 712 is a central controller 702 as described in FIG. 6. The controller 710 may be used to receive a request from the edge device 704c and initiate deployment of the message bus 708 associated with the producer at the local distribution center. In some embodiments, each time an edge device is brought online, a request for a message bus is provided to the controller 710, and a message bus 708 is configured and deployed at the edge device 704. Additionally, based on the hierarchy level of the edge device 704 as described in FIG. 3, the message bus 708 may be configured and provided to the edge device 704. For example, an RDC within the system may include one or more LDCs and may generate or collect more data.

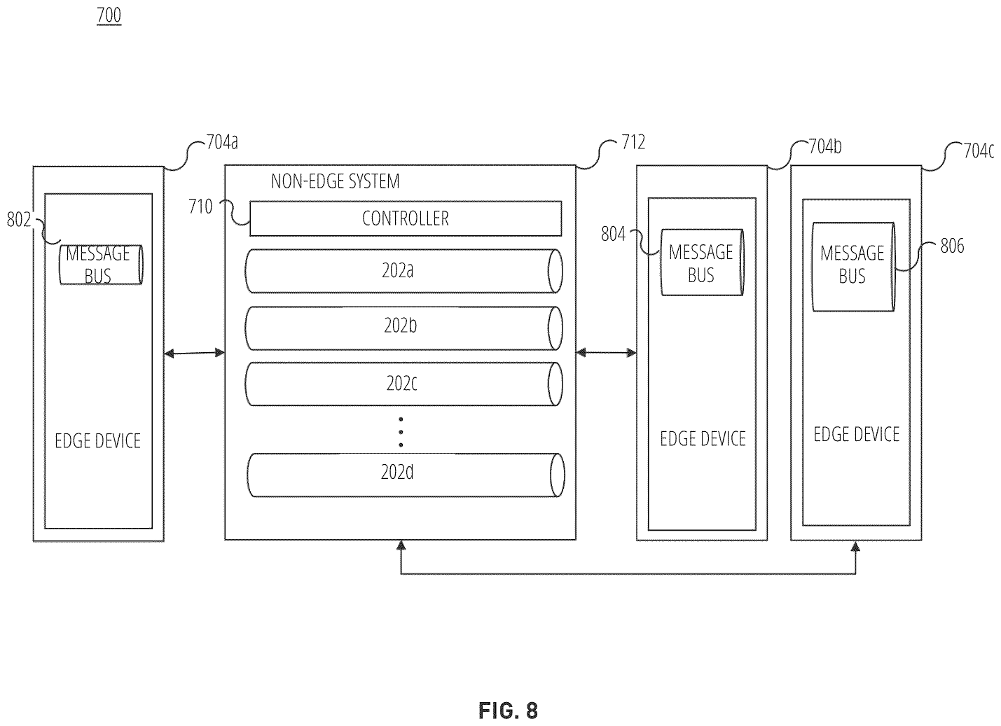

FIG. 8 shows telecommunication edge message buses 802, 804, and 806 deployed based on edge device 704 capabilities, according to at least one embodiment. As described in FIG. 7, a message bus 708 may be deployed at an edge device, such as edge device 704 of a telecommunication system 700. In some embodiments, configuring a message bus 708 for deployment may include creating a message bus 708 in response to the request and according to the specifications of the edge device 704. In some embodiments, pre-generated message bus configurations may be stored within, or accessible to, the controller 710. These pre-generated configurations may include message buses of varied sizes and transmission capabilities, each with different capacity and computational requirements. For example, a message bus 802 of a first size may not have as large a message throughput capacity as a message bus 804 of a second size. However, due to the decreased throughput capacity, the message bus 802 of the first size may require fewer resources to support than the higher capacity message bus 804, thus decreasing producer resource utilization. Resources of the edge device 704 to support a message bus 802, 804, or 808 may include, but are not limited to, central processing specifications, memory, bandwidth, and the like. In some embodiments, the higher the throughput capacity of the message bus, the more resources of the edge device 704 are required to support the message bus.

In some embodiments, the size of a message bus to be distributed to an edge device 704 is determined based on configuration settings included in the request, such as size limitations of the edge device 704. In some embodiments, the request is provided during configuration of the edge device 704 and may include desired specifications of the message bus or specifications of the deployment location. For example, in a request, an edge device 704a may indicate a desired message bus 802 capacity. The message bus 802 may be provided to the edge device 704a only if it satisfies the desired capacity specified in the request. In some embodiments, the request provided by the edge device 704a may include identifiers associated with a specific message bus 802 capacity. For example, message buses may be identified as Size A, Size B, Size C, and the like. As part of the request, the edge device 704 may indicate the desired message bus 802 by requesting “Size A.” In some embodiments, only the desired capacity or specific message bus 802 identification may be used by the telecommunication system 700 to determine which message bus 802 to deploy.

In some embodiments, the sizing and configuration of message buses deployed at edge devices 704 may be influenced by the presence and operational requirements of a RIC 302. The RIC 302, whether deployed locally at the edge or operating in a distributed fashion, may require access to specific types and volumes of telemetry data to support near-real-time and non-real-time analytics, policy enforcement, and network optimization. As a result, the anticipated data throughput required by the RIC 302 may be utilized when determining the message bus size and capacity at each edge location. For example, an edge device 704 may host a near-real-time RIC responsible for managing handovers across a dense urban cluster of RUs and distributed units (DUs). The RIC 302 may ingest and process high-frequency telemetry streams from dozens or even hundreds of sub-producers deployed throughout the coverage area. To support the RIC 302, the edge device 704 may require a message bus with high capacity.

In some embodiments, the edge device 704a may provide a request for a message bus 802. The request may include information about edge device 704a, such as memory, bandwidth, and expected output. In some embodiments, this edge device information may be provided as part of the request, for example, as input to a request generated by a user. Alternatively, the edge device information may be collected by the edge device 704 and sent with the request. In other embodiments, the edge device information may be identified automatically by the central controller 710. For example, if an edge device 704 is being connected to the telecommunication system 700, specifications for the edge device 704 may be provided to the telecommunication system 700 during configuration. When requesting deployment of a message bus 802, the telecommunication system 700 may utilize the specifications of the edge device 704 collected during the connection process. For instance, an edge device may have a set capacity for data intake. Using this capacity, the controller 710 may identify a message bus with a capacity that satisfies the data generated by the edge device 704.

In some embodiments, when generating a request for a message bus, an edge device 704 may set default information based on its specifications. For example, an edge device 704 may have a set capacity for data intake. When attempting to request a message bus 802, the request may be auto-populated to generate a message bus 802 that can handle all data potentially generated by the edge device 704. However, in some cases, an edge device 704 may have a potential capacity for data intake but may not be intended to operate at full capacity. Since message buses 802 utilize resources of the edge device 704, it may be beneficial to request deployment of a message bus 802 configured for expected capacity rather than possible capacity. In such embodiments, a user and/or an automated system may update the populated fields to reflect the anticipated throughput rather than the maximum possible throughput of data.

Using the requirements for the message bus provided by the request, the system 800, for example at the controller 710, may identify one of the pre-generated message bus configurations. For example, a first message bus 802 may have a throughput capacity of 100 megabits per second (Mbps), a second message bus 804 may have a throughput capacity of 500 Mbps, and a third message bus 806 may have a throughput capacity of 1 Gbps. If the request indicates that the edge device 704a may have an expected throughput requirement of 80 Mbps, the controller 710 may determine that the first message bus 802 should be deployed to the edge device 704a.

In some embodiments, edge devices 704 may be existing components of system 800 that require a message bus to be deployed after the edge device 704 has already been integrated into the system 800. In such embodiments, the controller 710 may have access to information regarding the edge devices 704 to determine which message bus 802, 804, or 806 to deploy. In some embodiments, based on the point of connection within system 800, the controller 710 may be able to infer message bus characteristics. For example, an edge device 704 of a first type may be identified as being deployed in a highly populated region based on its connection point. An edge device 704 deployed in a highly populated region may be expected to output the maximum amount of data. Conversely, an edge device 704 of the same type deployed in a less populated region may not be expected to operate at full capacity. Based on the region of deployment, the controller 710 may determine that a message bus capable of handling the maximum throughput should be deployed in the highly populated region, while a message bus with lower throughput may be deployed in the less densely populated region.

In some embodiments, an edge device 704 may require more than one message bus to satisfy throughput requirements. In some embodiments, rather than select a preconfigured message bus of a larger size, the controller 710 may determine that resource allocation would be better served by using two message buses of a smaller size. For example, the first message bus 802 may require a first number of resources, while the second message bus 804 may require a second number of resources, which is more than twice the first number of resources. An edge device 704a may request a message bus with a throughput capacity requirement of 110 Mbps. The message bus 802 with the lowest throughput capacity would not satisfy the requirements of the edge device 704a. However, two message buses of the first size (message bus 802) would satisfy the throughput capacity requirement of the edge device 704a. The controller 710 may determine that the resources of the edge device 704a would be better utilized by deploying two message buses 802 of the first size instead of deploying a single message bus of the second size.

In some embodiments, selecting a message bus for deployment within a system 800 (such as message buses 802, 804, and 806) may be accomplished using artificial intelligence and machine learning. In some embodiments, systems 800 may include tens or even hundreds of edge devices 704. Edge devices 704 may not all be configured at the same time and may not all request message bus deployment simultaneously. As additional edge devices 704 of similar types are added to the system 700, the system 700 may learn the expected capacity of similar edge devices 704. In such embodiments, rather than requiring a message bus request or specific requirements as part of a message bus request, the system 700—such as at the controller 710—may utilize learned traits of edge devices 704 to determine which size of message buses 802, 804, and 806 to deploy. In some embodiments, artificial intelligence systems may be trained using expected yields based on edge device type and may be updated during use depending on message bus requirements identified during operation.

FIG. 9 illustrates an example graphical user interface 900 for data producers 204 connecting to the message buses 202 of FIG. 2, according to at least one embodiment. As described in FIG. 2 to FIG. 7, a producer 204 may provide data to one or more consumers 206 via one or more message buses. In some embodiments, upon integration with the system 200, a producer 204 may provide producer information to the system, for example, at the controller 710. To properly connect producers 204 to message buses and provide data to consumers 206, the system-such as at the controller 710—may utilize producer information to determine to which message buses the producer 204 should connect. As shown, for example, in FIG. 4, producers 204 may be configured and/or directed to supply data to one or more message buses. In some embodiments, producer information may include client characteristics of the producer, such as characteristics regarding components used at the producer. For example, a characteristic of a producer could include CPU metrics, storage capacity, antenna transmission packet size, and so on.

Onboarding a producer 204 to a system, such as an edge device 704, may include registering the producer 204 via a graphical user interface. The graphical user interface 900 may be accessible over an internet connection, via source code input on the producer 204, direct line communication with the system 200, or similar means. The graphical user interface 900 for connecting the producer 204 to the system may first identify that the device providing the information is intended to be a producer 204 within the system 200. In some embodiments, the graphical user interface 900 may include an interaction object 902 for indicating that the provided information is for a producer 204. In other embodiments, the graphical user interface 900 may be limited to only accepting producer information, and no interaction object 902 may be required for the onboarding process of the producer 204.

As described above in FIG. 1 to FIG. 4, a producer 204 may include one or more subcomponents, such as O-RAN producers, which may need to be treated individually by the system when connecting the producer 204 to the message bus. For example, each subcomponent may be directed to a different message bus or may include identifying data during transmission to indicate the O-RAN producer source. The number of sources may be provided to the graphical user interface through an input interaction object 904, which allows a user to input the exact number of data sources, such as the number of O-RAN components. In some embodiments, if a user and the system do not have readily identifiable information on the number of sources utilized by the producer 204, the user may interact with a detection interaction object 806 that can identify, within the producer, the number of subcomponent producers that need to be accounted for.

In some embodiments, the graphical user interface 900 may be used to identify where the message bus should be deployed. As shown, a drop-down interaction object 808 can be used to select whether a message bus residing on the central system, a first local edge device, or a second local edge device will be used for the producer 204. As described in FIG. 5 and FIG. 6, a non-edge system may comprise one or more message buses 202. When connecting the producer 204 to the system, a user or computing device at the producer 204 may determine that the data produced by the producer 204 is best served using a message bus at the non-edge system. For example, if the data does not require, or would not be significantly better served by, decreased latency of data communication over a message bus, the user and/or the computing system of the producer 204 may select the central message bus from the drop-down interaction object 908.

In some embodiments, a telecommunication system may include multiple levels of abstraction away from the central system, such that one or more edge devices, for example edge devices 704, may depend on each other. A first local message bus may be stored on an edge device at a higher hierarchical level than the producer 204 is going to be deployed on. For example, Local 1 may be a message bus deployed on an RDC edge device, and producer 204 may be deployed on an LDC edge device which connects to the central system through the RDC. may the user and/or the computing system of the producer 204 determines that the data produced by producer 204 requires lower latencies than would exist if transmitted through a message bus on the central system, but does not require the data transmission rates achievable by a message bus on the producer 204, Local I may be selected from the drop-down interaction object 908, thus connecting the producer 204 to a message bus deployed on a nearby edge device 704.

In some embodiments, as described above, data produced by a producer, for example at an LDC in a densely populated area, may require low latency data communication through a message bus to consumers 206. In such embodiments, the user and/or the computing system of the producer 204 connecting the producer 204 to the message bus may identify Local 2 or the producer 204 itself as the location for deployment of the message bus.

In some embodiments, the graphical user interface 900 for connecting the producer 204 to a message bus may include data about the producer 204 that can be used by the central controller 710 when determining an appropriate message bus for the producer 204. In some embodiments, the graphical user interface 900 may include an interaction object, depicted as a button, which directs the system to self-identify data that may be relevant for the controller 710. In some embodiments, a producer 204 may be intended to connect to an already established message bus. For example, an RDC may be connected to two or more LDCs within a telecommunications system. A first LDC may be connected via the graphical user interface 900. During the connection of the first LDC to the system, a message bus may be deployed at the RDC and connected to the first LDC as a producer. The second LDC may subsequently be connected to the system via the graphical user interface 900. When connecting the second LDC, the user may indicate, using a source drop-down interaction object 912, that an existing system message bus should be used. A second interaction object may appear, in some embodiments, to allow the user to identify the desired message bus, for example, the message bus on the RDC that is connected to the first LDC.

In some embodiments, the user may determine that the advantages of a message bus on a cloud computing system, for example, message bus 708 in cloud 706 of FIG. 7, would be best for the producer 204. In such embodiments, the user may select the existing external message bus for connection to the producer 204. In some embodiments, a new producer 204 may be a new source for which a user does not have an identifiable message bus. Rather than automatic identification of structure using the identify structure interaction object 910, the user may interact with the source drop-down interaction object to input new source details, such as transmission capacity, packet size, storage capacity, and the like. The inclusion of the new source data may allow the controller 710 to generate and/or identify a message bus based on the required specifications of the producer 204.

In some embodiments, if a new source requires a new message bus to be deployed on the producer 204, the user may use deployment language interaction objects 914. The controller 710 may have the capability to generate and/or deploy a message bus in a first language and a second language on a producer. In some embodiments, a producer may be configured to understand and interpret the first language and/or the second language. However, in some cases, the producer 204 may not be able to support deployment of a message bus in the first language or the second language, in which case the user may identify another language in which the message bus may be deployed.

In some embodiments, deployment of a message bus in a third language may require the controller to generate a message bus, or a bridge to message bus code in the first language and the second language, that may be deployed on the producer 204. In some embodiments, upon receiving indication of a third language selection, the controller 710 may direct the producer 204 to generate data that is normalized in such a way that it may be supported by a message bus in the first language or the second language. For example, the controller 710 may provide the producer 204 with an expected format for data that may be passed through a message bus in the first language or the second language, and may direct the user to change data output formatting from the third language to formatting that may be supplied to the message bus in the first language or the second language.

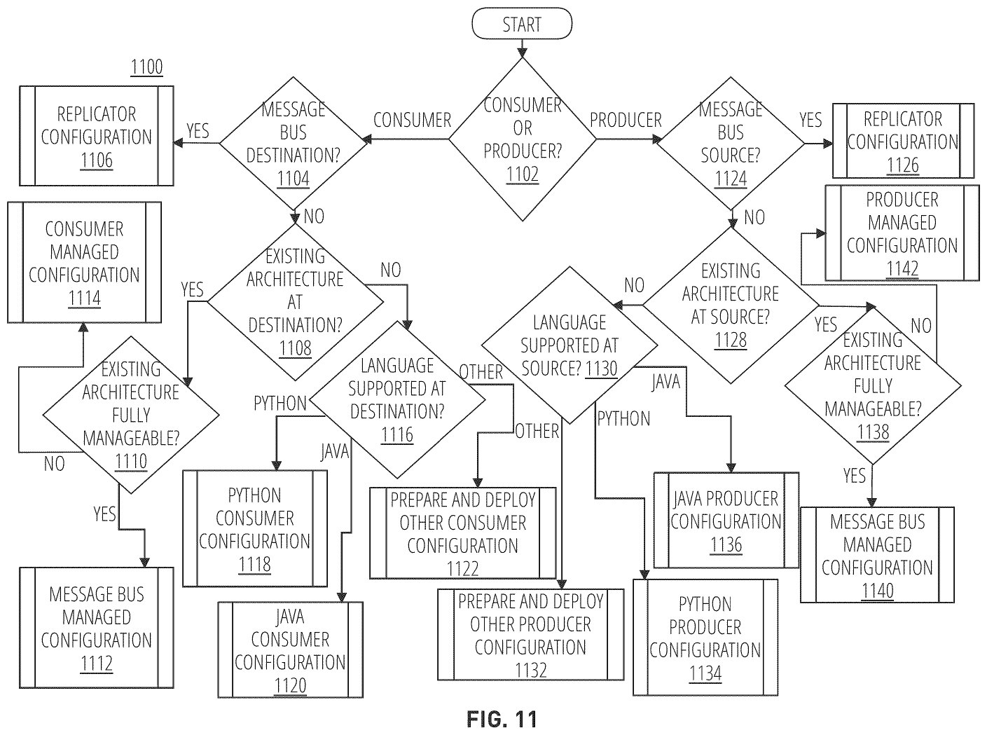

In some embodiments, the data that is supplied to, or retrieved 918 by, the message bus may be provided with identifiers 916 generated as part of the data. As described in more detail in FIG. 11, the data identifiers 916, or topics, may be retrieved for the producer 204 and listed for the user to identify which topics may be transmitted with the data and which topics may be disregarded. Topics may be used to identify data that may be collected from a producer 204 and/or provided to a consumer 206. For example, a consumer may only be interested in data associated with an inventory topic, and by including inventory as part of the topics included in data identifiers, only inventory-related data may be transferred to the consumer 206. If the inventory topic is excluded from transmission, this may cause a message bus transmitting the data from the producer 204 to a consumer 206 to be unable to identify inventory-related data. Without the ability to identify the data, the message bus may not transmit inventory data to the consumer 206.

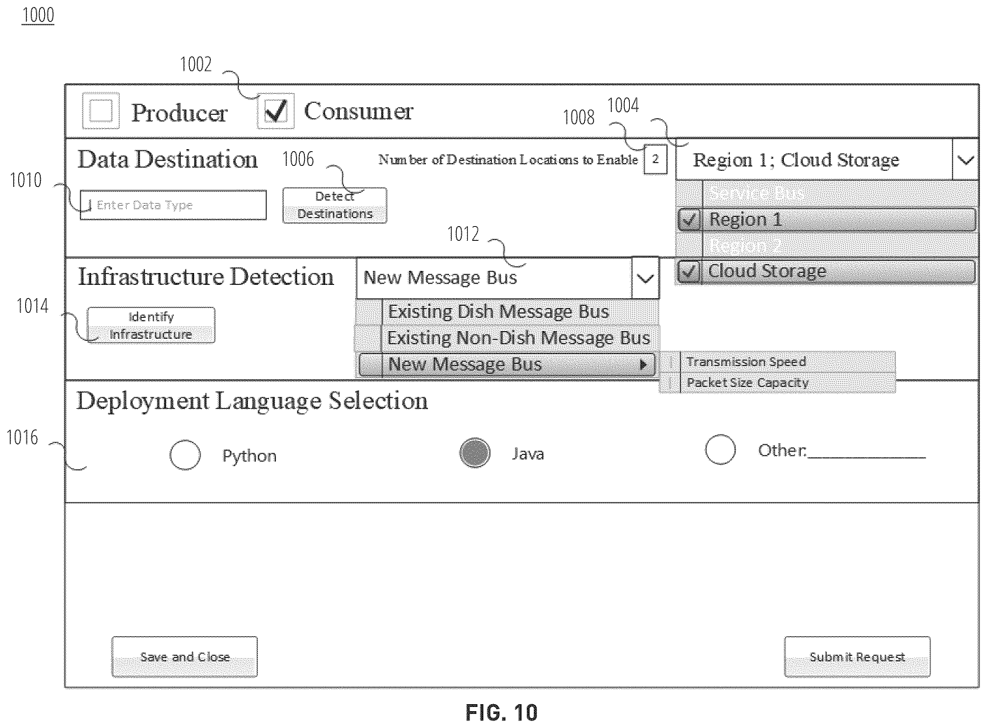

FIG. 10 illustrates an example graphical user interface for data consumers connecting to the message buses of FIG. 2, according to at least one embodiment. As described in FIG. 2 to FIG. 7, a consumer 206 may receive data from one or more producers via one or more message buses. In some embodiments, upon integration with the system 200, a consumer 206 may provide consumer information to the system, for example, at the controller 710, to enable connection to the appropriate message buses. To properly connect consumers 206 to message buses for data reception, the system-such as at the controller 710—may utilize consumer information to determine which message buses to connect to the consumer 206. As shown, for example, in FIG. 5, consumers 206 may be configured and/or directed to receive data from one or more message buses. In some embodiments, consumer information may include client characteristics of the consumer, such as details regarding components used at the consumer. For example, a characteristic of a consumer could include CPU metrics, storage capacity, antenna transmission packet size, and so on.

Onboarding a consumer 206 to a system may include registering the consumer 206 via a graphical user interface 1000. The graphical user interface 1000 may be accessible over an Internet connection, via source code input by the consumer 206, direct cable communication with the system 200, or similar means. The graphical user interface 1000 for connecting the consumer 206 to the system may first identify that the device attempting to connect is a consumer 206. In some embodiments, the graphical user interface 1000 may include an interaction object 1002 for indicating that the provided information is for a consumer 206. In other embodiments, the graphical user interface 1000 may be limited to only accepting consumer information, and no interaction object 1002 may be required for the onboarding process of the consumer 206.

As described above in FIG. 1 to FIG. 6, a consumer 206 may be dedicated to evaluating data from a region and/or slice of a telecommunication system, either as the data is being produced in real time or later in non-real time. Depending on the intended use of the data and the data to be consumed, the user may identify one or more destination locations using a drop-down destination interaction object 1004. A destination location may describe an area within the system where the consumer 206 intends to operate. For example, if a consumer 206 intends to operate on real-time data for a first region, the destination would be region one. If the consumer 206 intends to operate on real-time data for a second region, the destination would be region two. A consumer that does not intend real-time consumption of data may indicate cloud storage as the destination. A consumer 206 that designates cloud storage as a destination may not, in some embodiments, be a consumer 206 that consumes data, and may instead act as a data store for data supplied from the producers 204. In some embodiments, a destination may be a message bus. A message bus as the destination may enable the system to deploy a replicator as a consumer 206 that replicates the data passing through the message bus. Based on the destination, the system may determine the type of consumer 206 that will be receiving data and may identify deployment information to connect the consumer 206 with the message bus to ensure the data is properly handled according to the destination. For example, based on a cloud storage destination, the system may instruct the message bus to provide the data to a data store in the cloud storage. Based on a message bus destination, the system may determine a need to deploy a replicator to the message bus to replicate the data passing through the message bus.

In some embodiments, destinations may be detected using detection interaction object 1006. Using the object 1006, the consumer 206 may identify the destination from which the graphical user interface 1000 is being accessed. For example, using the object 1006, the consumer 206 might identify that the graphical user interface 1000 is being accessed via a cloud storage environment by a user device that is geographically located in region one. Therefore, the detected destinations may include both Region 1 and cloud storage. The user may, upon viewing the detected destinations, adjust the destinations according to user preference.

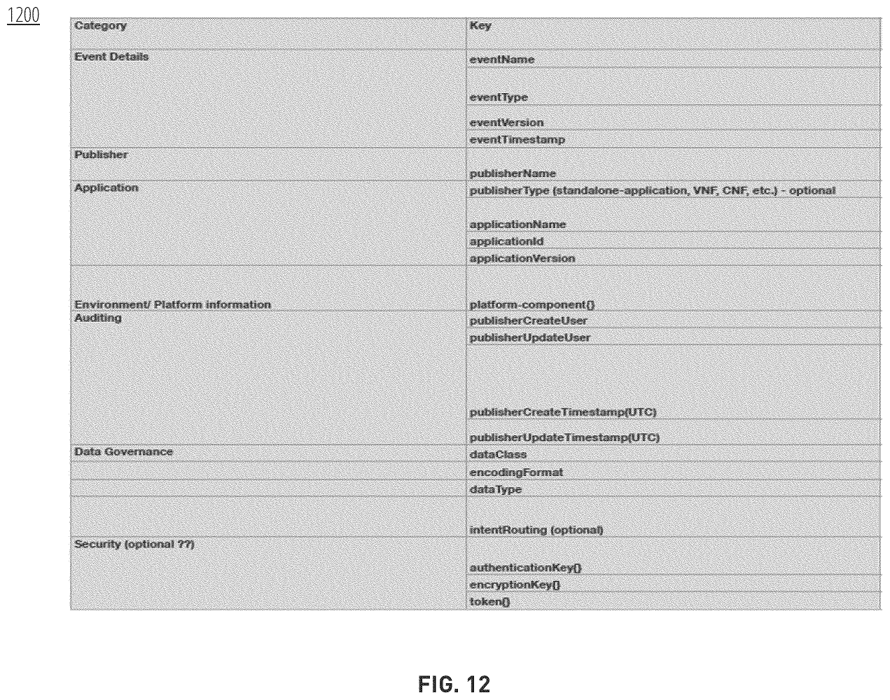

In some embodiments, data provided at a destination may be further limited by data type. As briefly described in FIG. 9 and more thoroughly described in FIG. 12, data generated by a producer 204 may be identified by one or more data types depending on the data generated. The consumer 206 may be limited to receiving data that it can utilize, as specified by user input at input interaction object 1010. When generating a consumer 206 that has one or more destinations, data types received by the consumer 206 may be segmented so that a first destination receives a first set of data types and a second destination may receive a second set of data types. For example, a consumer 206 that specifies a destination of Region 1 and a destination of cloud storage may indicate data types to receive at Region 1 that require real-time data analysis for real-time data consumption. The consumer 206 may designate one or more data types that do not require real-time data analysis to be received at the cloud storage destination. In some embodiments, the consumer 206 may utilize the data provided to the cloud storage destination. For example, if the consumer 206 has finished processing the data received at Region 1, it may then use the time to consume the data in cloud storage.

In some embodiments, a consumer 206 may be previously integrated into the system such that it is connected with one or more message buses. In such embodiments, the system, for example at the controller 710, may have stored an existing example connection point for the consumer 206. This existing example connection point may be used as a model to generate a new connection point. In some embodiments, the system may supply the additional data requested in the graphical user interface 1000 through the existing message bus. In some embodiments, the existing message bus may be external to the system, for example, a cloud storage message bus, through which the system may direct the additional data. In other embodiments, a connection point to a new message bus may be required for the consumer 206 to complete the request in the graphical user interface 1000. In such embodiments, the system, for example at the controller 710, may require an understanding of the infrastructure of the consumer 206 to create a connection point with the message bus. Depending on the type of bus required for the consumer 206, the user may identify the bus in the message bus drop-down interaction object 1012. In some embodiments, the graphical user interface 1000 may be used by the user to begin infrastructure identification using interaction object 914. In such embodiments, the consumer 206 may be queried to identify message bus connections and message bus capacity infrastructure. Rather than automatic identification of structure using the identify structure interaction object 1014, the user may interact with the bus drop-down interaction object 1012 to input new bus details, such as transmission speed, packet size capacity, and the like. The inclusion of the new bus data may allow the controller 710 to generate and/or identify message bus connections based on the required specifications of the consumer 206.

In some embodiments, if a new source requires a new message bus to be deployed to enable the connection, or a message bus connection point to be deployed, the user may use deployment language selectors 1016. The controller 710 may have the capability of generating and/or deploying a message bus in a first language and a second language, or enabling connection via the first language or the second language. In some embodiments, a consumer may be configured to understand and interpret the first language and/or the second language. However, in some embodiments, the consumer 206 may not be able to support deployment of a message bus in the first language or the second language, in which case the user may identify another language in which the message bus may be deployed.

In some embodiments, deployment of a message bus in a third language may require the controller to generate a message bus, or bridge to message bus code in the first and second languages that may be deployed on the consumer 206. In some embodiments, upon receiving indication of a third language selection, the controller 710 may provide the consumer 206 with a translation map to normalize data received from the message bus into a usable format.

FIG. 11 is a flow diagram 1100 of a method for smart producer message bus configuration and consumer message bus configuration, which may represent configurations of message bus connection architecture according to at least one embodiment. In the smart producer and consumer configuration, a data producer 204 or data consumer 206 may automatically or manually request to utilize the message bus communication logic 102 of the system 103. Automatic requests may be made when a producer 204 or a consumer 206 is first connected to the system 103. Manual requests may be made by a user at a producer 204 or a consumer 206, for example, by utilizing the graphical user interfaces 900 and 1000 of FIGS. 9 and 10. To generate message buses 202 and/or message bus connections to a producer 204 or a consumer 206, the system-such as at the controller 602—may use a smart configuration process. The process may start by determining whether the device attempting to connect to the system is a consumer or a producer. If the connection request is made by a consumer 206, the controller 602 may determine if the message bus is the destination 1104 of the data being requested by the consumer 206. A message bus 202 may be identified as a destination by a consumer 206 that may not need the data immediately but may access the data at a later time.

If the message bus is the destination of the data, the controller 602 may determine a need to deploy a replicator configuration 1106 to replicate the data for storage at a location other than the consumer 206. A replicator configuration may exist in combination with the message bus to replicate the data being passed through the message bus to the consumer 206. Rather than passing data directly to a consumer, the data is simply replicated and may be provided in a secondary location for storage. In some embodiments, replicating the data via a replicator configuration used in tandem with the message bus may be initialized for the purpose of fault tolerance. For example, if the data is important to overall system health and/or may be necessary for data interpretation at a later time, the data may be replicated to preserve it in case of a fault. The replicator may allow the data to be stored in a separate location from either a consumer 206, the producer 204, or any data store for data produced by a producer 204 that is being maintained for future use and is not being supplied to a consumer 206. In some embodiments, the replicator configuration 1106 may be implemented for scalability, allowing multiple consumers to connect to the replicas and reducing the load on any single instance of data. In other embodiments, the replicator configuration 1106 may be implemented for data consistency, aiding in strong data consistency through a distributed system by enabling replication throughout the system to achieve widespread data storage.

If the message bus is not the destination 1104, the controller 602 may identify whether an existing message bus architecture exists at the destination 1108. Existing message bus architecture may include, for example, a message bus connection point that was previously established to a message bus housed on the system. A message bus housed on the system, for example, may be a message bus 202 on the non-edge system or a message bus on an edge device 704. In some embodiments, a previous connection point may establish a connection to a message bus that is maintained by the system but stored in the cloud computing environment.

If there is existing message bus architecture at the destination 1108, the controller 602 may determine whether the existing message bus architecture is fully manageable 1110 by the message bus. Fully manageable architectures may include a message bus connection that is fully manageable and therefore reconfigurable by the system. Non-fully managed message bus configurations may be either entirely externally managed or partially externally managed, such that the controller 602 has only partial or no control over the message bus configuration. In some embodiments, an externally managed message bus configuration may be managed, for example, at a cloud computing system, wherein the cloud computing system may possess some or all management over the message bus configuration and may limit system control over the cloud system message bus configuration. In other embodiments, a message bus configuration may be housed on a consumer 206 external to the system, such that the device on which the message bus configuration resides may have full or partial control of the message bus configuration.

For example, consumer 206 may be a device within the system that is controlled by the system. As part of the system, the consumer 206 may include message bus architecture that is fully manageable by the controller 710. Alternatively, a consumer 206 connected via a cloud storage system may grant limited permissions for the controller 602 to adjust the message bus architecture and connections via the cloud storage system. In some embodiments, a consumer 206 may be completely external to the system, such that any configurations are provided as requests to the consumer 206 and are implemented at the discretion of the consumer 206, not at the direction of the controller 602.

If the existing message bus architecture is fully manageable 1110, the controller 602 may deploy a message bus managed configuration 1112 on the consumer 206 to enable new or alter existing message bus connections between the consumer 206 and the message bus. In some embodiments, based on a new request provided by the consumer 206, the service may identify a need to connect the consumer 206 to a message bus that is receiving alternative data from one or more producers 204. In a situation where the existing message bus connection is fully managed by the message bus, the controller 602 may adjust the connection independently of external allowances to establish the connection between the message bus and the consumer 206.

If the existing message bus architecture is not fully manageable 1110, the controller 602 may deploy a consumer managed configuration 1114. If the system does not have the ability to fully manage the message bus architecture on the consumer 206, the consumer 206 may be required to execute steps in order to deploy the proper message bus configurations to complete the request.

Returning to the logic decision to determine if the existing architecture is at the destination 1108, if the destination does not include existing message bus architecture, controller 602 may identify a language supported at the destination 1116. As described above, a destination may include a region, a consumer device identifier, a cloud computing environment, and the like. In some instances, a destination may be configured to understand and utilize a specific coding language. If the destination utilizes a Python coding language, the controller 602 may deploy a Python consumer configuration 1118 to connect the destination to a message bus for the first time. If the destination utilizes a Java coding language, the system may deploy a Java consumer configuration 1120 at the destination to connect the consumer 206 to a message bus for the first time.

Although the logic flow 1100 only depicts the system identifying Python and Java, it should be appreciated that the system may be configured to identify additional coding languages and have a ready-made consumer configuration for each identifiable coding language. In some embodiments, a destination may be identified as using a language that is not correlated with a pre-existing consumer configuration. In such embodiments, the controller 602 may prepare and deploy another consumer configuration 1122 based on the identified coding language. Preparing and deploying another consumer configuration may include, for example, creating a deployment configuration in the supported language, creating a bridge between pre-existing deployable configurations and the coding language identified in the consumer 206, creating a mapping for the consumer 206 to interpret the deployment configuration and translate the code into identifiable code for the consumer 206, and the like.

Returning to logic decision 1102, if the device attempting to connect with the system is a producer, the controller 602 may determine whether the message bus is the source 1124. As described above with the consumer 206, if the message bus is determined to be the source of the data, the controller 602 may deploy a replicator configuration 1026 so that any data passed into the message bus is replicated. Upon determining that the message bus is not the source 1124, the controller 602 may determine whether there exists a message bus architecture at the source 1128.

Existing message bus architecture at the source may include a message bus at the source, a message bus connector at the source, and similar components. A message bus at the source, as described above, may include, for example, a message bus deployed at an edge device 704. A message bus connector at the source may include, for example, a connection configuration for connecting the producer, such as an edge device 704, to a message bus 202 stored at a non-edge system. Existing message bus architecture may indicate that the source has previously been integrated into the system and is supplying data to one or more message buses. If there is existing message bus architecture at the source 1128, the controller 602 may identify whether the existing message bus architecture is fully manageable by the system, as indicated by the existing architecture fully manageable 1138.

In some embodiments, the producer 204 may be connected to a message bus that is not fully managed by the system. Without full manageability of the message bus, the system—for example, at the controller 602—may be unable to autonomously configure or reconfigure an update to the connection or the message bus. For example, a message bus stored on the cloud computing system may be partially or fully managed by the cloud computing system. In such embodiments, the system may not be able to adjust the connection between the cloud computing system at the message bus and the source within the system. In some embodiments, the producer 204 may not be managed by the system and may instead be a device configured to provide data to the system for system use. A producer 204 could reside externally to the system; for example, temperature sensors and weather sensors configured to identify temperature and weather patterns near edge devices of the system. By utilizing temperature and weather pattern data from the external producer 204, the system may better interpret and categorize the data produced at system edge devices. If a producer 204 that is externally managed is attempting to connect to, or reconfigure, a connection with a message bus, the message bus architecture may be fully managed by the producer 204 that is external to the system.

If there is fully manageable existing message bus architecture within the producer 204, the system may deploy a message bus managed configuration 1140. The message bus managed configuration may be a new configuration to connect the source to a new message bus, a reconfiguration message to alter existing connections between the producer 204 and the message bus, or similar actions. If the existing message bus architecture is not manageable by the message bus, the system may deploy a producer managed configuration 1142. The producer managed configuration may include, for example, a request to a message bus manager to adjust the connection between the producer 204 and the message bus. In some embodiments, the request may include a request to initialize an attachment between the producer 204 and a message bus managed external to the system. In some embodiments, the producer managed configuration 1142 may include requests to the producer 204 that is managed externally to the system, allowing the producer to enable a connection with a system message bus.

If there is no existing message bus architecture at the source 1128, the system may identify a language supported at the source 1130. As described above, the system may be configured to generate and manage connections to message buses in a limited number of coding languages. For those coding languages, the system may maintain deployment configurations. If the language supported at the source is Java, the system may deploy a Java producer configuration 1136 at the producer 204. If the language supported by the source is Python, the system may deploy a Python producer configuration 1134 at the producer 204. If the language supported at the source is not a language that is standardly supported by the system, the system may prepare and deploy another producer configuration 1132. It should be appreciated that the system may support Java, Python, and/or other coding languages, but is not limited to those coding languages. When preparing and deploying another producer configuration 1132, the system may generate a message bus in the identified coding language, generate a key for mapping the preconfigured deployments into the identified coding language, or generate a bridge to normalize the data from the identified language to connect to a pre-existing producer configuration.

FIG. 12 shows an illustrative topic governance logic 1200 for next-generation data configuration according to at least one embodiment. As described above, the system may include O-RAN components managed by multiple vendors. Due to the disaggregation of network functions and the use of multiple interoperable components from different vendors, data may be provided to message buses using topic governance logic (e.g., identifiers) that enable the data to be transmitted to the appropriate consumers. O-RAN components may produce large volumes of data with vendor-specific formatting and naming conventions.

In some embodiments, within the telemetry data framework of FIG. 1, controllers, and/or message buses, standardized topic governance for the various components may enable efficient and real-time data transmission of the large amounts of data produced by the disaggregated components. At the producers, for example, at O-RAN components managed by one or more vendors, the data is generated and attached to metadata and/or unique identifiers that are published to a topic within the system. Within a disaggregated telecommunication system, metadata and unique identifiers may include data type, vendor identifier, event details, publisher, application, environment/platform information, auditing, data governance, security, log topics, data stream topics, broadcast topics, topics for notifications, transactional topics, and state topics.

In some embodiments, a large language model (LLM) may parse a string of metadata and/or identifiers provided with data from a vendor. The LLM may first tokenize the input text into smaller units (tokens) to understand its structure. It may then apply deep learning algorithms to map the tokens to their semantic meaning, recognizing intent, entities, and relationships. The LLM may convert the mapped tokens into a standardized form, ensuring consistent interpretation regardless of variations in phrasing or syntax.

In some embodiments, generating a map between vendor metadata and identifiers and the standardized form for the system may occur upon configuration of a producer. As discussed above, a producer may be onboarded into the system and may request connections to message buses. When connecting to message buses, the system may identify metadata and identifiers that could potentially be generated by the producers and may use the LLM to generate a mapping between the vendor structure and the system structure. In some embodiments, the mapping may occur at the message bus, at a controller, or at a telemetry data framework through which all data may be routed prior to transmission through a message bus.

In some embodiments, a map between vendor metadata and identifiers and the standardized form for the system may occur upon deployment of a configuration. During initial onboarding, a producer may provide some or all of the possible metadata and identifiers for the vendor. In some embodiments, the producer may provide only metadata and identifiers intended to connect with the message bus identified by the initial request. If, at a later time, there is a need to provide additional data associated with different metadata and identifiers, a new mapping or an amendment to an existing map may be created.

In some embodiments, vendor metadata and identifiers may be mapped to a preferred topic governance topology. The context of the payload, as shown in the table of FIG. 11, may include categories of data (e.g., data types) that are identifiable within the metadata and data identifiers that may be used to normalize the data using standard naming conventions. The categories may include event details, publisher details, application details, environmental information, auditing information, data governance information, and/or security information. Each category of data may be broken down into multiple subcategories that further describe the data being provided.

For example, within the event details category, an identifier may specify a piece of data as an event name. An event name may still be associated with the data type of event data but is specific to the name of an event. Additional event subcategories may include type, version, and timestamp. The publisher category may include a publisher name subcategory. The publisher's name may include the application that is publishing the data. This publisher may include a vendor name and may be used to generate the mapping. For example, if a mapping exists within the system for a vendor associated with the publisher's name, the system may utilize the previous mapping rather than generating a new one.

In some embodiments, an application detail category may include publisher type, application name, application ID, and application version. The publisher type may indicate the type of application that is published in the data, the application name may identify the name of the application publishing the data, the application ID may identify the application publishing the data, and the application version may identify the version of the application that is generating the data. The environmental information category may include a subcategory that defines a platform component. The platform component may include data that describes the dynamic assignment between a pod and an application. The auditing category may include subcategories such as publisher create user, publisher update user, publisher create timestamp, publisher update timestamp, and similar items. Subcategories within the auditing category may be used to identify users of the publisher and the times at which records created by the users were generated. The data governance category may include data class, encoding format, data type, and Internet routing. The data governance category may also include data that is generated based on data transmission. The security category may include subcategories that define authentication keys, encryption keys, tokens, and similar items.

When creating a mapping or providing data through a message bus from a producer, the system may include metadata and identifier strings that have been normalized by the system. The context of the payload, identified using the categories, may be used to create names that may be programmatically manageable and usable for the system. Names may be descriptors used in a data string that is provided to identify data to the message bus for transmission. For example, the samples listed in Table 1 are example names.

TABLE 1

| Component | Description | Sample |
|---|---|---|
| Organization | Entity to which the data belongs | Dish-5g |
| Wireless Domain | Domains defined for the organization's | Enterprise |
| | network | |
| Functional area | Operational function in the wireless | inventory |
| | domain | |
| Capability | The sub-function | unified |
| Data Type | Logs, notifications | |
| Network | Where in the system the data originated | NDC |
| Topology | in the context of the system | |
| Data state | Stage of data type | raw |

Viewing the components shown in Table 1, the consumers may require data indicating network topology to determine the health of, for example, a specific NDC. Thus, the network topology may be provided as part of the data string to the consumer. In some embodiments, the string may be expected to be in an order that includes all components without skipping any. For example, the system may be unable to provide a data string that includes only the data type without including the preceding components. In some embodiments, placeholder values for the previous components may be input into the data string so that only the data type information is usable.

In some embodiments, the data string may include limitations that are applied when generating names for components within the data string. For example, if a wireless domain uses the name “enterprise,” no other wireless domain may be entered into the naming system with the same name. In some embodiments, a name is limited to 250 characters per topic and may include restrictions on which characters can be used. For example, the organization may be named “dish-5g” with a dash, but not “dish_5g” with an underscore.

When mapping metadata and identifiers from the producer, the system may generate additional names based on information found in the context of the payload. For example, the system may use a publisher name or a variation of a publisher name to generate an organization name for use in the data string. In some embodiments, the system may require the generation of all types of data upon a request by a producer to join the system. An administrator or user of the producer may be required to generate names according to the naming standards for the data string before the producer is connected to the system. In some embodiments, the administrator or user attempting to connect the producer to the system may generate proposed names according to naming standards and submit them for approval. Approval may occur automatically via an internal check performed by, for example, the controller, or may be completed by a system administrator. Only once the names have been approved may the producer be configured as part of the system and a message bus or message bus connections be deployed.

The RIC 302 may leverage topic governance to efficiently filter, subscribe to, and process only the telemetry data streams relevant to its operational objectives. Topic governance may provide a standardized framework for classifying data produced by a wide array of sub-producers and vendors. The labeling may allow the RIC 302 to dynamically select and act upon the most pertinent information for each of the xApps and rApps without being overwhelmed by irrelevant or redundant data.

For example, the RIC may be tasked with monitoring the health and performance of a specific network domain, such as the “Dish-5g” wireless domain. To monitor the health of the domain, the RIC may utilize a specific set of xApps and rApps that use some, but not all, telemetry data created by the domain. For example, it may collect network topology data originating from the National Data Center (NDC). Using the topic governance logic outlined in the table, each telemetry message may be tagged with structured metadata fields such as Organization (“Dish-5g”), Wireless Domain (“Enterprise”), Functional Area (“inventory”), Data Type (“logs” or “notifications”), Network Topology (“NDC”), and Data State (“raw”). The RIC 302 can subscribe to topics that match this combination of attributes to receive only the inventory logs and notifications relevant to the NDC within the Dish-5g domain.

In some embodiments, not all metadata, identifiers, and their accompanying data are usable or may be utilized by a producer within the system. Specifically, data may cover a sizable portion of the system or may be generated for a small portion of the system. Data specialized for a small portion of the system may not be useful for determining the overall health of the system and edge devices. By eliminating the passage of data that indicates specialized data for a small portion of the system, the system may cause the message buses to be utilized efficiently and prevent consumers from being flooded with unusable data. As shown in FIG. 9, the truncation of topics and data associated with topics provided to a consumer or a message bus may be performed by a user via a graphical user interface 800, selecting topics to be provided with their accompanying data. For example, the data retrieved and/or input into the graphical user interface 1000 includes six data topic categories. After selecting the components to be transmitted, the system may generate a data string that includes the data in the order defined by the table.

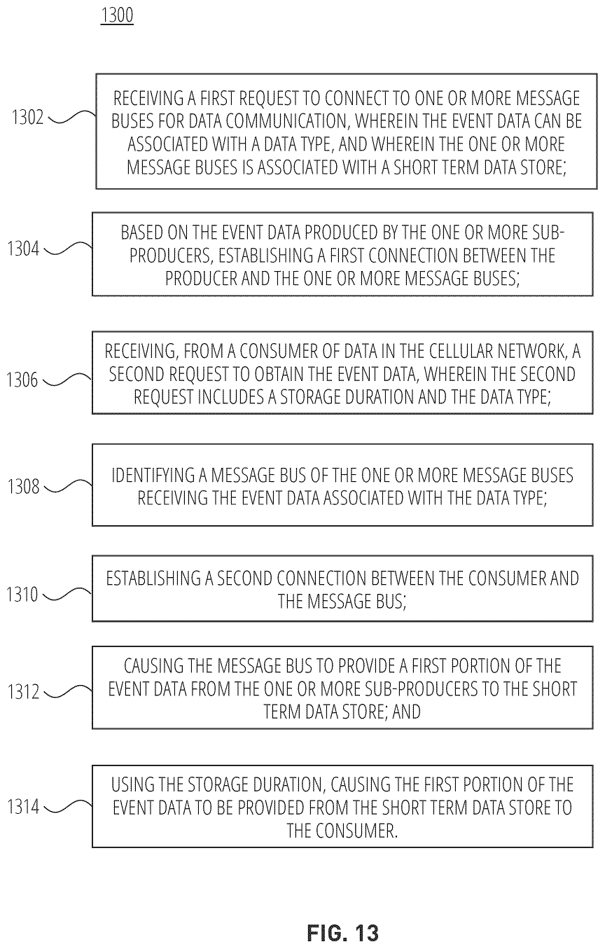

FIG. 13 is a flow diagram 1300 of a method for providing real-time and non-real-time service communication channels according to at least one embodiment. In some embodiments, the system described, for example, the system 103 in FIG. 1, may be a next-generation cellular network that can be utilized to connect one or more producers 204 with one or more consumers 206 for real-time data transmission and consumption. In some embodiments, data may be transmitted via one or more message buses 202 (e.g., distributed communication modules). The message buses can, in some embodiments, include a short-term data store and a memory, and the message bus is configured to receive next-generation transmissions of event data from a client with sub-producers. The one or more message buses 202 can, in some embodiments, receive and interpret requests to connect a producer 204 and/or a consumer 206 (e.g., a client) to the message bus 202 to facilitate data transmission. In some embodiments, the one or more message buses 202 may connect one or more producers 204 to a long-term data store, such as data store 208. The message buses may be in data communication with a controller of the next-generation network.

The method may begin with the system 200 receiving, from a producer 204 of data in a cellular network 108, a first request to connect to one or more message buses 202 for data communication. The producer 204 may comprise one or more sub-producers 210 generating event data associated with the cellular network 108, and the event data may be associated with a data type. Further, the one or more message buses 202 may be associated with a short-term data store 214.

In some embodiments, the request includes a storage duration for the event data and a data type of the event data to be provided to the client making the request. The communication including the request may be received at a communication interface of the system 200 that can receive messages from a producer 204, a consumer 206, and/or another user device. In some embodiments, the request may be generated by a user and/or automatically generated based on producer 204 and/or consumer 206 data throughput requirements. For example, based on a consumer's interaction with the system at the consumer interface, as shown in FIG. 9, a user may be enabled to identify a data type desired for consumption. Additionally, the request may include identification of one or more storage durations for a portion or for all of the data types. A storage duration may indicate to a message bus 202 whether the data associated with the data type may be passed directly through the message bus 202 to a consumer 206 or whether the data associated with the data type may be passed through the message bus 202 to a long-term storage device such as data store 208.

For example, a request may identify a first data type and a second data type. The first data type may be requested to be stored for a short storage duration, and the second data type may be requested to be stored for a long storage duration. Based on the data type, a first portion of the event data associated with the first data type may be stored in the short-term data storage of the message bus, and a second portion of the event data associated with the second data type may be stored in the long-term data storage by the message bus. The second portion may be provided to a consumer based on an indication from the consumer that the consumer is ready for the data, automatic transmission based on consumer business needs, and the like.

In some embodiments, the request may be submitted by a user to reconfigure and/or determine the storage duration of data types during system operation. In other embodiments, a request may be automatically generated upon initialization of a system 200 based on preset storage durations for data types. For example, a data type may be time-dependent, such that low latency is beneficial. The data type may then include a storage duration that indicates the data may be passed directly to any consumers 206 that request to receive data of that data type. Conversely, a data type may not be time-dependent, such that low latency is not beneficial. In such embodiments, initialization of the system 200 may include a preset storage duration for the data type that indicates the data associated with the data type may be provided from the message buses 202 to a long-term data store. In some embodiments, a message bus 202 may be associated with a short-term data store 214, and a system 200 may include a long-term memory such as a data store 208. In some embodiments, the request, when received at the message bus (e.g., the message bus 202), may be utilized to set up rules for the message bus 202 to control the flow of data based on the data type and the storage duration.

At block 1304, the method 1300 may include based on the event data produced by the one or more sub-producers 210, the system 200, for example at the message bus communication logic 102 of FIG. 1, may establish a first connection between the producer and the one or more message buses 202.

At block 1306, the system 200 may receive a second request from a consumer of data in the cellular network to obtain the event data. In some embodiments, the request may include a storage duration and a data type. The storage duration may indicate a length of time between event data creation and delivery of the event data to the consumer. In some embodiments, the storage duration may be used to determine whether the event data associated with the data type that is to be provided to the consumer from the message bus should be stored in a short-term data store associated with the message bus, a long-term data store, or not stored at all.

At block 1308, the system 200, for example at the message bus communication logic 102 of FIG. 1, may identify a message bus among the one or more message buses that is receiving event data associated with the data type. In some embodiments, the data type may include identification of one or more data producers, indication of a parameter of the data such as temperature, speed, etc., indication of a device creating the data, and the like. For example, the data type may be temperature data from all servers in a geographical region. The system 200 may identify any message bus that is receiving temperature data from the servers.

At block 1310, based on the data type produced by the one or more sub-producers 210, the system 200, for example at the message bus communication logic 102 of FIG. 1, may establish a second connection between the consumer and the one or more message buses 202.

At block 1312, the system 200, for example at the message bus communication logic 102 of FIG. 1 and/or using the controller, for example controller 710, may cause the message bus to provide a first portion of the event data from the one or more sub-producers 210 to the short-term data store. In some embodiments, the one or more sub-producers 210 may produce event data associated with multiple data types. Based on the storage duration received as part of the request, the event data associated with the data type may be provided to a short-term data store.

At block 1314, the first portion of the event data is provided from the short-term data store to the consumer 206 for consumption, for example at the message bus communication logic 102 of FIG. 1 and/or using the controller, for example controller 710.

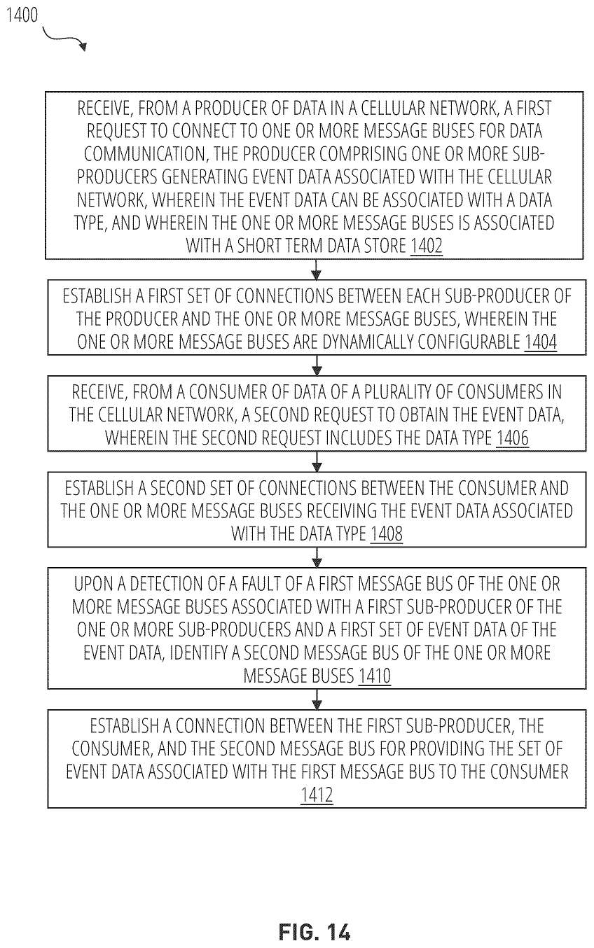

FIG. 14 is a flow diagram 1400 of a method for intelligent communication channel generation for next-generation data transmission according to at least one embodiment. As described above in at least FIG. 6, a system may include a first message bus and a second message bus, each containing storage and memory. The first and second message buses may be dynamically configurable such that they may be managed by a controller, such as central controller 602. The method begins at block 1402, where the controller may receive, from a producer of data in a cellular network, a first request to connect to one or more message buses for data communication. In some embodiments, the producer may comprise one or more sub-producers generating event data associated with the cellular network. In some embodiments, the event data may be associated with a data type, and the one or more message buses may be associated with a short-term data store. The first producer, as described above, may be a producer 204 or a sub-producer 210. The request received at the controller may be one or more configuration requests as described in at least FIG. 8 and FIG. 9. The request may be a request to initialize a producer as part of the system and connect the producer to a message bus. In some embodiments, the request may include details about the producer or any of the one or more sub-producers to enable message bus assignment and/or deployment that may properly handle the data throughput required by the first producer, such as at one or more sub-producers.

At block 1404, the system may establish a first set of connections between each sub-producer of the producer and one or more message buses, where the message buses are dynamically configurable. In some embodiments, the connection is established when a message bus, such as message bus 708, is deployed at a producer, for example, at an edge device 704. In some embodiments, the connection may include a connection enabled by the producer that is managed by the system. In such embodiments, the system may configure a connection point at the producer for communication with a message bus. In some embodiments, a producer and/or each sub-producer of a producer may be partially or not manageable by the system, and the connection may involve deploying a partially or non-manageable set of requests to enable the first sub-producer to connect with the message bus at the direction of a controller.

At block 1406, the system may receive, from a consumer of data among a set of consumers in the cellular network, a second request to obtain the event data, wherein the second request includes the data type. As described above in at least FIG. 10 to FIG. 11, the consumer may be connected to the system through a graphical user interface or other methods by providing the details of the data and the consumer. In some embodiments, the consumer may request data and may define a storage duration for specific data types. In some embodiments, the consumer may request data from a specific producer and/or sub-producer.

At block 1408, based on the request to connect the first consumer of data to receive data from the first producer, the controller may connect the first consumer to the first message bus. As described above, connecting the consumer to the message bus may include, for example, deploying a fully manageable, partially manageable, or non-manageable configuration to connect the consumer to the message bus based on the permissions of the controller to manage deployed configurations on the consumer.

After the connection is established, in some embodiments, at block 1410, upon detection of a fault in a first message bus of the one or more message buses associated with a first sub-producer of the one or more sub-producers and a first set of event data, the system may identify a second message bus among the one or more message buses. In some embodiments, a fault may include a disruption in the data transmission from the first producer or first sub-producer through the message bus to the consumer. In some embodiments, the second message bus may be selected based on its utilized capacity as known by the controller. In some embodiments, the controller may identify the second message bus as one that already has an existing connection to either the first consumer and/or the first producer or sub-producer, such that additional configuration deployments are not required upon connection to the second message bus.

In some embodiments, to connect the first producer and the first consumer to the second message bus, new configuration deployments may be required at the first producer and the first consumer to establish the connection. In some embodiments, the controller may maintain a map of connections between the producers, the message bus, and the consumers. In some embodiments, after connecting the first producer and the first consumer to the second message bus, the controller may update the map of connections. In some embodiments, upon detection of a fault, the controller may identify connections that may be appropriate for the first producer and the first consumer to resume data communication. An appropriate message bus may be one that can handle the data throughput required by the connection. In some embodiments, multiple message buses may be identified by the controller as being appropriate for connecting the first producer and the first consumer. In some embodiments, the controller may be configured to analyze existing connections, potential data throughput from other producers and consumers, potential data throughput between the first producer and the first consumer, and similar factors to determine which of the appropriate message buses may be used.

At block 1412, the system may establish a connection between the first sub-producer, the consumer, and the second message bus to provide the set of event data associated with the first message bus to the consumer.

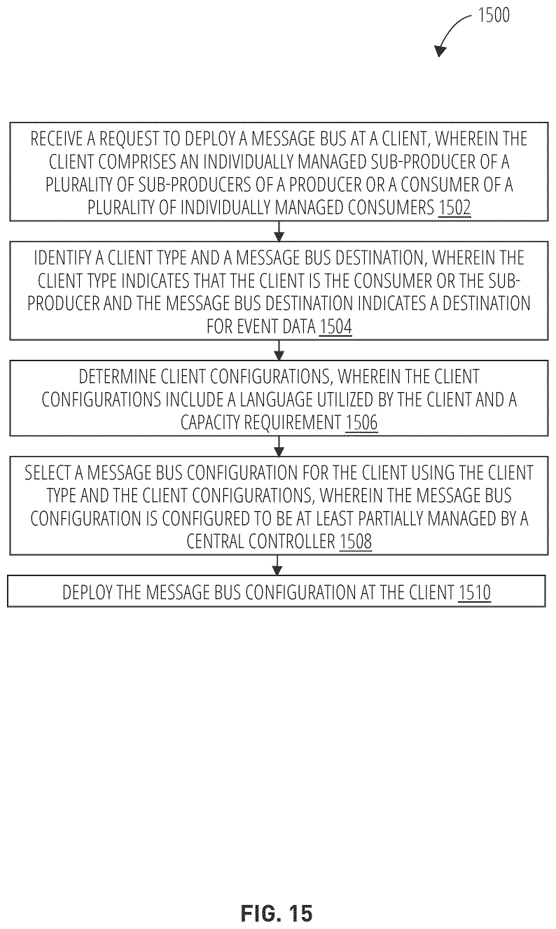

FIG. 15 is a flow diagram 1500 of a method for connecting clients to a message bus according to at least one embodiment. In some embodiments, clients may include a producer 204 and/or a consumer 206. Beginning with block 1502, the system may receive a request to deploy a message bus at a client, where the client comprises an individually managed sub-producer of sub-producers of a producer, or a consumer from individually managed consumers. As described above, a request to deploy a message bus may be a request to deploy a message bus 708 at an edge device 704, as shown in at least FIG. 7 and FIG. 8, or may be a request to deploy a configuration to enable data communication between a client and a message bus, as described in at least FIG. 11.

At block 1504, the system identifies a client type and a message bus destination, where the client type indicates whether the client is a consumer or a sub-producer, and the message bus destination indicates a destination for event data. In some embodiments, the client type may indicate whether the client is a producer, a sub-producer, or a consumer. In some embodiments, a message bus data destination may include defining whether the destination is the message bus, a fully manageable client, a partially manageable client, a non-manageable client, a cloud computing system, or similar. The message bus data destination may indicate where the message bus and/or the configuration for enabling message bus communications may be deployed. In some embodiments, the message bus configuration is a replicator, based on the destination designating the message bus.

At block 1506, the system may determine client configurations, which include a language utilized by the client and a capacity requirement. A client configuration may be included in deployment requests and may include, for example, a language for deployment, a message bus configuration, and similar parameters. In some embodiments, determining client configurations may include identifying client information. In some embodiments, rather than reading a request to obtain all information required for generating a configuration, client configurations may be identified based on client characteristics. Client characteristics may include, for example, model types of client hardware, central processing specifications, memory, bandwidth, client position within a system, and other characteristics that may be determined based on automatic inspection of the client requesting integration into the system. Central processing specifications may refer to technical details of the hardware specifications of the client devices.

At block 1508, the system may select a message bus configuration for the client using the client type and the client configurations, and the message bus configuration is configured to be at least partially managed by a central controller. In some embodiments, generating the message bus configuration may include generating a message bus with specifications that satisfy the request. In some embodiments, generating a message bus configuration may also include generating connection-enabling requests that may be provided to the client and utilized by the client to connect to the message bus. In some embodiments, the generated configuration may be based on a coding language identifiable and usable by the client. In some embodiments, based on the data destination, for example, if the message bus is the data destination, the configuration may be a replicator. As described above, a replicator may be used within a message bus to replicate data that passes through the message bus, based on the data type requested to be provided to the replicator. Replicator data may be used to safeguard against loss of data during a fault, data corruption, and similar issues. In some embodiments, selecting the message bus configuration may include identifying that the language utilized by the client is not an expected language and generating a client message bus configuration for the client using the client type and the client configurations.

In some embodiments, the method may continue at block 1510 by deploying the message bus configuration at the client. In some embodiments, depending on the manageability of the client, the central system may have the ability to alter the configurations after deployment. In some embodiments, deploying the message bus configuration may include maintaining the connection between the client and the message bus communication device.

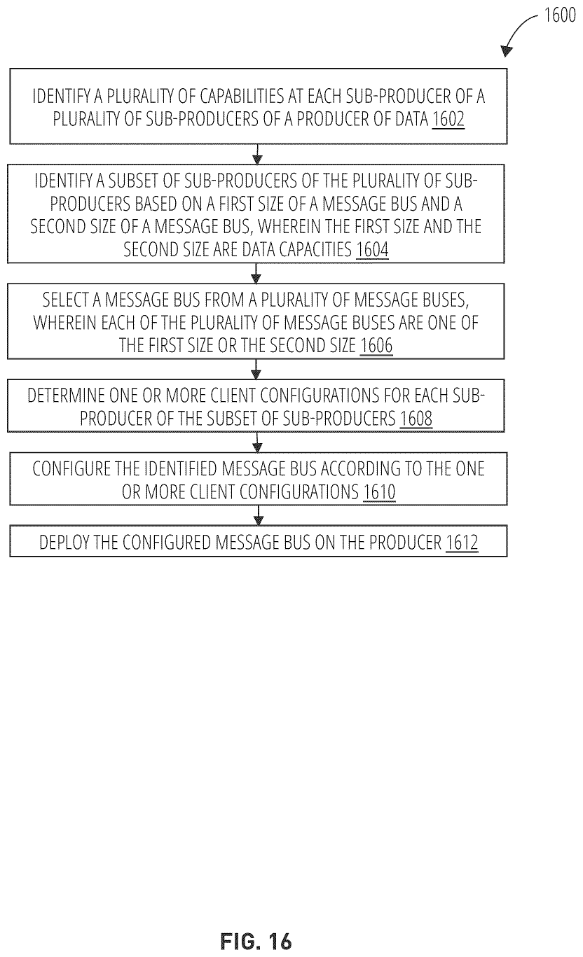

FIG. 16 is a flow diagram 1600 of a method of selecting and providing message buses at edge telecommunication locations, according to at least one embodiment. As described above, for example in FIG. 8, in some embodiments the system may include the capability to have pre-generated message buses that can be deployed at edge devices. The method begins at block 1602 by identifying capabilities for each sub-producer among sub-producers of a data producer. In some embodiments, the capabilities of a producer may include, but are not limited to, computational support ability, storage availability, expected data throughput, expected data type generation, and similar attributes. These capabilities may be provided via a graphical user interface 1000, where a user defines the capabilities of the producer. Alternatively, the system may identify the producer's capabilities based on known characteristics. For example, an edge device that is an RDC with expected components may have a predictable capacity for the aforementioned attributes. In some embodiments, the system may infer the capacities of a producer by referencing previous capabilities of similar producers. For example, an LDC connected to an RDC may have similar capacities to another LDC connected to the same RDC and running the same components.

At block 1704, a subset of sub-producers may be identified from the sub-producers, based on a first size and a second size of a message bus, where the first and second sizes represent data capacities. For example, a first message bus may be configured with a first throughput size, and a second message bus may be configured with a second throughput size. Depending on the capacities identified for the producer, either the first or second throughput size may be selected, allowing the system to identify the appropriate on-site message bus for deployment. In some embodiments, identifying the message bus may include determining a destination for the message bus, confirming that the message bus has not previously been connected to the producer, and determining a language supported by the producer.

In some embodiments, identifying a message bus from message buses may involve selecting two distributed data modules of the first throughput size rather than a single module of the second throughput size. Selecting the first and second message buses may be intended to satisfy the producer's capacity requirements while minimizing resource utilization. For example, if the required capacity exceeds that of the second throughput size but can be met by combining two first throughput size modules, this approach may be chosen. The first size may be associated with a first throughput capacity and a first level of resource utilization, while the second size may be associated with a higher throughput capacity and higher resource utilization. For example, a second throughput size may require double the computational resources but provide more than twice the capacity of the first throughput size. By selecting two of the first throughput size, the system may limit computational resource usage to the lowest possible amount based on the pre-set sizes, while still meeting the required capacity.

After identifying a message bus, at block 1606, selecting a message bus from message buses, where each message bus is either the first or second size. In some embodiments, the pre-generated message bus may be configured based on producer and/or consumer settings. For example, the message bus may be set up to provide a first set of data to short-term storage and a second set of data to short-term storage, based on data type and distribution time. In some embodiments, the message bus may also be configured according to the manageability of the producer. For example, if the producer is managed externally to the system, the message bus may need to be configured so that the producer's administrator can receive and deploy the configured message bus internally. In some embodiments, the message bus may need to be set up to accept telemetry data framework-normalized data from sub-producers that generate data for next-generation telecommunication systems.

At block 1608, determining one or more client configurations for each sub-producer in the subset of sub-producers. As discussed above, when preparing to deploy a message bus, the system may require client configurations to generate and deploy a proper instance of the message bus. A client configuration may include an intended destination for the message bus, and different destinations may require different configurations. For example, a destination may be a producer on which the message bus may be deployed directly, a consumer that only needs a communication interface deployment to facilitate connection with the message bus, or a message bus that requires a replicator configuration for replicating selected data. In some embodiments, connections may have already been generated, and rather than reconfiguring instructions-such as a communication interface deployment for a consumer—the system may utilize the previously generated deployment to shorten computation time for generating a new deployment.

At block 1610, the identified message bus may be configured according to the one or more client configurations. In some embodiments, to generate a deployment that may be usable at a source, the client configurations may include a language supported by the producer. As described above, next-generation telecommunication systems may utilize open radio access network (O-RAN) components. O-RAN components may be provided by one or more vendors and are wholly owned and operated by those vendors. Each vendor may determine the best coding language for their purposes. As such, in a system with five sub-producers, each managed by a separate O-RAN vendor, the system may be required to accept event data generated at producers running five different coding languages. In order to create a connection point between the producers and the message bus, the system may need to configure the deployment in the specific language usable by the O-RAN vendor.

At block 1612, deploying the configured message bus on the producer. In some embodiments, deployment may include continually enabling the connection between the system, controller, the message bus, the producer, the consumer, and the like. In some embodiments, deploying the configured message bus may include providing requests to an externally managed producer to deploy the provided communication device.

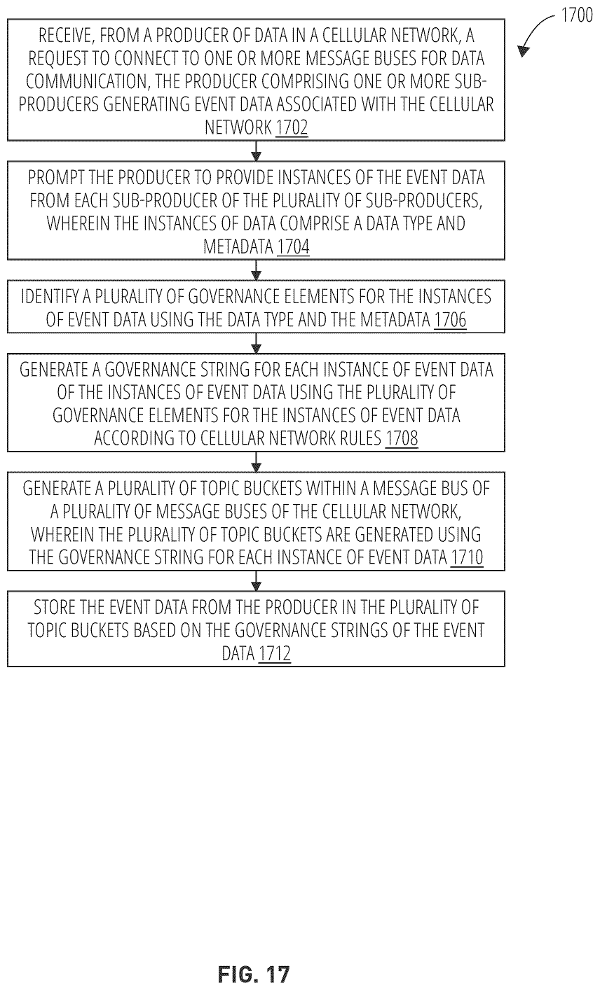

FIG. 17 illustrates a flow diagram 1700 of a method of identifying data for message bus transmission based on topic governance rules according to at least one embodiment. The method begins at block 1702. The system receives, from a producer of data in a cellular network, a request to connect to one or more message buses for data communication. The producer comprises one or more sub-producers generating event data associated with the cellular network. As described above in at least FIG. 8 and FIG. 12, the request to connect to the producer may be a request to connect your producer for the first time, or a request to connect a producer to provide additional data information not previously included in configurations. The sub-producers may be O-RAN producers that are each managed and completely controlled by an external vendor. Each vendor of the sub-producers may determine naming conventions and data collection methods for the sub-producer, which may need to be normalized to be properly understood by a message bus and accurately passed to a consumer. The request may include client configurations that may be used to understand and interpret the data provided by the sub-producer, for example, a programming language utilized at the sub-producer.

At block 1704, the system may prompt the producer to provide instances of event data from each sub-producer in the sub-producers, and the instances of data comprise a data type and metadata. The system prompts the producer to provide instances of event data for the sub-producers. As described above, a producer may be, for example, an edge device such as an LDC that includes sub-producers, which may be O-RAN components. The sub-producers may each be associated with a distinct vendor or may share common vendors. The producer may generate one or more instances of event data that indicate the event data the producer intends to provide to the system for data transmission to a consumer. The event data may be usable by the consumer and associated with specific event types, or may be examples of all event data that may be produced by the producer. The instances of event data may be provided in the format generated by the producer and not in a format altered for use by the system. For example, a producer generating communication data may provide raw event data as it is produced at the producer.

At block 1706, the system may identify governance elements for the instances of event data using the data type and the metadata, as described in FIG. 13. To identify these governance elements, the system may analyze the context of the payload from the sub-producers. As described above, by analyzing the payload context, the sub-producers—either autonomously or with user assistance—may identify the types of data that need to be named according to the system's normalized naming conventions. In some embodiments, the context is identified using an LLM, user identification, or similar methods. Using the payload context, the naming conventions of the data instances (e.g., producer naming conventions) may be mapped to the governance elements (e.g., names) as defined by the message bus system rules (e.g., naming rules). As previously described, names may be generated according to a set of naming rules that specify the allowable characters in the data string. In some embodiments, names may be generated by a producer administrator, a system administrator, a generative AI model, or similar sources, and the like. In some embodiments, the system may also generate and maintain a mapping between the payload context and the naming conventions used by the producer, as well as the generated names according to the system's normalized naming conventions.

At block 1708, generating a governance string for each instance of event data using the governance elements, in accordance with cellular network rules. As described above, the data string may be generated in an order specified by the system's naming convention rules, so that the data string is structured as expected by other system components. After generating the data string, the system can determine a string length for the governance string for each instance of event data, based on input from the producer's administration, system administrators, autonomous system evaluation, preset string length, or similar criteria. The governance string for each instance of event data will have a preset string length according to cellular network rules and will include at least one governance element. The governance string length may refer to the number of characters in the data stream, the number of data types included, or similar metrics. For example, a governance string length may be defined to include three components: the organization, the wireless domain, and the functional area. In some embodiments, the governance string length may specify the number of characters to be transmitted as part of the data string, with those characters forming part of the names.

As described above, the message buses may include short-term data stores, and the system may also include long-term data stores for storing data. Consumers may request that data be stored in either the short-term or long-term data store based on event types. Event types may be identified using the names within the data stream. Each piece of data from an organization may be part of an event type associated with that organization, and each piece of data associated with a wireless domain may be part of an event type for that wireless domain. Event types may be segmented at any level within the data stream. For example, event types segmented by organization may be at the highest level, so that any data produced by the organization is considered part of the event type. An event type segmented by wireless domain may include one or more segments, depending on the number of wireless domains within the organization. Such segments may only include event types associated with both the wireless domain and the organization, and data associated with the organization may be split between segments associated with the wireless domains. The event types may be segmented within the short-term and long-term data stores, depending on the request submitted by the consumer.

Turning to block 1710, to separate the event types within the short-term and long-term data stores, the system may generate topic buckets within a message bus of the cellular network. The topic buckets are generated using the governance string for each instance of event data. As described above, event types to be stored in the short-term data store are those that the consumer has designated for low-latency data transmission. Therefore, any topic buckets within the short-term data store may be exclusive to that store, while topic buckets within the long-term data store may be associated with less time-sensitive event types.

At block 1712, the event data may be stored in the topic buckets based on the governance strings of the event data. When event data is provided from the producer to the message bus, the message bus may review the normalized naming convention data string to determine the event type associated with the topic buckets within the short-term data store and the long-term data store. Data associated with topic buckets in the short-term data store may be transferred to the short-term data store for temporary storage before being transmitted to the consumer, while data associated with topic buckets in the long-term data store may be transferred to the long-term data store. In some embodiments, the event data within the short-term data store may be provided to a consumer prior to event data from the long-term data store. In some embodiments, the event data stored in the first set of topic buckets is provided to the consumer before the event data stored in the second set of topic buckets to the consumer. In some embodiments, the event data stored in the first set of topic buckets is provided to the consumer, and the event data stored in the second set of topic buckets is maintained in the second set of topic buckets until the consumer requests the data or a time metric is met. The time metric may be set by the system or a user to control the duration for which event data is maintained in the long-term data store.

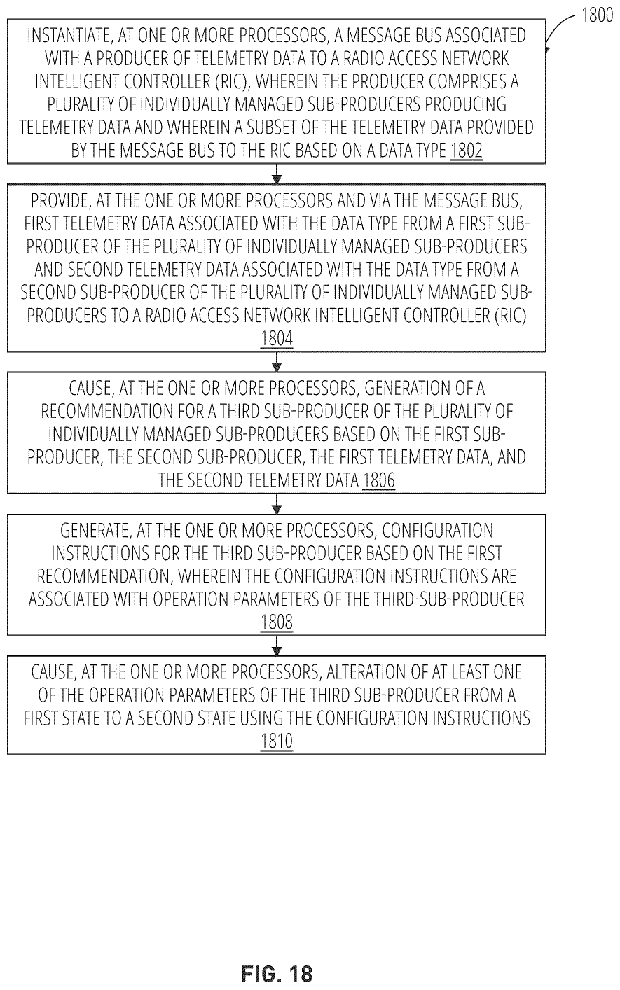

FIG. 18 illustrates a flow diagram 1800 of a method of utilizing message bus transmission for RIC 302 operations according to at least one embodiment. In block 1802, the method of flow diagram 1800 begins by initializing, through one or more processors, a message bus associated with a producer of telemetry data to a radio access network intelligent controller (RIC 302), and the producer comprises individually managed sub-producers producing telemetry data, and a subset of the telemetry data is provided by the message bus to the RIC 302 based on a data type. The producer may be implemented by a network component such as a radio unit, distributed unit, or centralized unit (as referenced in FIG. 3). The producer may include multiple sub-producers, each generating localized event data and operating independently of one another. Upon initialization, the message bus is configured with a short-term data store and a rules engine. This engine may classify incoming telemetry by data type, ensuring that only telemetry relevant to the RIC 302 is forwarded, while other data may be retained or discarded based on applicable service-level policies. Instantiating the message bus may include receiving a request for telemetry data from the RIC 302, and the request comprises the data type, identifying telemetry data associated with the data type from the first sub-producer and the second sub-producer, and connecting the message bus to receive the telemetry data associated with the data type from the first and second sub-producers and provide the telemetry data to the RIC 302.

In block 1804, providing, for example at the message bus, first telemetry data associated with the data type from a first sub-producer of the individually managed sub-producers and second telemetry data associated with the data type from a second sub-producer of the individually managed sub-producers to the RIC 302. Based on indications from the RIC 302, the message bus may only provide telemetry data of a requested data type. Specifically, it propagates first telemetry data from a first sub-producer and second telemetry data from a second sub-producer, both directed to the RIC 302. The message bus may apply functions such as protocol translation, data de-duplication, and time alignment to ensure the data streams form a coherent and temporally synchronized feed appropriate for near-real-time analysis within the RIC's internal messaging and storage subsystems.

In block 1806, causing, for example at the RIC 302, the generation of a recommendation for a third sub-producer among the individually managed sub-producers, based on the first sub-producer, the second sub-producer, the first telemetry data, and the second telemetry data. The recommendation may be generated by invoking analytic or policy-based logic, for example, using an rApp or xApp, to process the aggregated telemetry from the first and second sub-producers. Based on this analysis, the RIC 302 may generate a recommendation targeting a third sub-producer associated with the same original producer. The recommendation may specify an operational adjustment intended to enhance performance, reduce risk, or otherwise optimize network operation in response to the observed telemetry.

In block 1808, using the same processors or those of a CM 308 integrated with a CI/CD framework 310, generating configuration instructions for the third sub-producer based on the recommendation. These configuration instructions are associated with operational parameters of the third sub-producer and are readable instructions that encode the recommended changes. These instructions may define specific operational parameters for the third sub-producer. The generation may include causing the execution of at least one application external to the next-generation cellular network. The operational parameters of the third sub-producer may include one or more of a hardware configuration, software configuration, and network setting.

In block 1810, causing, at the RIC 302, alteration of at least one of the operational parameters of the third sub-producer from a first state to a second state using the configuration instructions. The alteration may include the RIC 302 coordinating the controlled deployment of the configuration artifacts to the third sub-producer via the CI/CD framework 310. This may update one or more operational parameters from their initial to revised states. During this deployment, the telemetry pathway through the message bus remains active, allowing the RIC 302 to monitor third telemetry data from the message bus for assessment. If a specified criterion is satisfied, the routine may cause alteration of at least one of the operational parameters from the second state back to the first state as a rollback procedure if the changes result in negative consequences. The criterion is associated with allowable operating thresholds.

The method of flow diagram 1800 may further include, based on an indication of message bus failure, instantiating a replacement message bus, connecting the producer of telemetry data to the replacement message bus, connecting the RIC 302 to the replacement message bus, and causing the transmission of telemetry data from the producer to the RIC 302.

In the above description, numerous details are set forth. However, it may be apparent to one of ordinary skill in the art, having the benefit of this disclosure, that embodiments may be practiced without these specific details. In some instances, well-known structures and devices are shown in block diagram form rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm, as used herein, is generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “determining,” “sending,” “receiving,” “scheduling,” or the like, refer to the actions and processes of a computer system or similar electronic computing device that manipulates and transforms data represented as physical (e.g., electronic) quantities within the computer system's registers and memories into other data similarly represented as physical quantities within the computer system's memories or registers, or other such information storage, transmission, or display devices.

Embodiments also relate to an apparatus for performing the operations described herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), magnetic-optical disks, Random Access Memories (RAMs), EPROMS, EEPROMs, magnetic or optical cards, or any type of media suitable for storing electronic instructions. One or more non-transitory, computer-readable storage media may have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems may appear from the description below. In addition, the present embodiments are not described with reference to any particular programming language. It may be appreciated that a variety of programming languages may be used to implement the teachings of the present embodiments as described herein. It may also be noted that the terms “when” or the phrase “in response to,” as used herein, may be understood to indicate that there may be intervening time, intervening events, or both, before the identified operation is performed.

It is to be understood that the above description is intended to be illustrative, not restrictive. Many other embodiments may be apparent to those skilled in the art upon reading and understanding the above description. The scope of the present embodiments should, therefore, be determined with reference to the appended claims, along with the full scope of equivalents to which such claims are entitled.

In the above description, numerous details are set forth. However, it may be apparent to one of ordinary skill in the art, having the benefit of this disclosure, that embodiments may be practiced without these specific details. In some instances, well-known structures and devices are shown in block diagram form rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm, as used herein, is generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as apparent from the above discussion, it is appreciated that throughout the description, discussions utilizing terms such as “determining,” “sending,” “receiving,” “scheduling,” or the like, refer to the actions and processes of a computer system or similar electronic computing device that manipulates and transforms data represented as physical (e.g., electronic) quantities within the computer system's registers and memories into other data similarly represented as physical quantities within the computer system's memories or registers, or other such information storage, transmission, or display devices.

Embodiments also relate to an apparatus for performing the operations described herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), magnetic-optical disks, Random Access Memories (RAMs), EPROMS, EEPROMs, magnetic or optical cards, or any type of media suitable for storing electronic instructions. One or more non-transitory, computer-readable storage media may have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems may appear from the description above. In addition, the present embodiments are not described with reference to any particular programming language. It may be appreciated that a variety of programming languages may be used to implement the teachings of the present embodiments as described herein. It may also be noted that the terms “when” or the phrase “in response to,” as used herein, may be understood to indicate that there may be intervening time, intervening events, or both before the identified operation is performed.

It is to be understood that the above description is intended to be illustrative, not restrictive. Many other embodiments may be apparent to those skilled in the art upon reading and understanding the above description. The scope of the present embodiments should, therefore, be determined with reference to the appended claims, along with the full scope of equivalents to which such claims are entitled.

What is claimed is:

1. A computer-implemented method for telemetry-driven orchestration of a next-generation cellular network, the method comprising:
instantiating, at one or more processors, a message bus associated with a producer of telemetry data to a radio access network intelligent controller (RIC), wherein the producer comprises a plurality of individually managed sub-producers producing telemetry data, and wherein a subset of the telemetry data is provided by the message bus to the RIC based on a data type;
providing, at the one or more processors and via the message bus, first telemetry data associated with the data type from a first sub-producer of the plurality of individually managed sub-producers and second telemetry data associated with the data type from a second sub-producer of the plurality of individually managed sub-producers to a radio access network intelligent controller (RIC);
causing, at the one or more processors, generation of a recommendation for a third sub-producer of the plurality of individually managed sub-producers based on the first sub-producer, the second sub-producer, the first telemetry data, and the second telemetry data;
generating, at the one or more processors, configuration instructions for the third sub-producer based on the recommendation, wherein the configuration instructions are associated with operational parameters of the third sub-producer; and
causing, at the one or more processors, alteration of at least one of the operational parameters of the third sub-producer from a first state to a second state using the configuration instructions.

2. The computer-implemented method of claim 1, wherein generation of the recommendation further comprises causing execution of at least one application external to the next-generation cellular network.

3. The computer-implemented method of claim 1, wherein the operational parameters of the third sub-producer include one or more of a hardware configuration, software configuration, and network setting.

4. The computer-implemented method of claim 1, wherein causing alteration of the at least one of the operational parameters further comprises:
monitoring third telemetry data from the message bus; and
based on satisfaction of a criterion, causing alteration of the at least one of the operational parameters from the second state to the first state.

5. The computer-implemented method of claim 4, wherein the criterion is associated with allowable operating thresholds.

6. The computer-implemented method of claim 1, further comprising:
based on an indication of message bus failure, instantiating, at the one or more processors, a replacement message bus;
connecting, at the one or more processors, the producer of telemetry data to the replacement message bus;
connecting, at the one or more processors, the RIC to the replacement message bus; and
causing, at the one or more processors, transmission of the telemetry data from the producer of telemetry data to the RIC.

7. The computer-implemented method of claim 1, wherein instantiating the message bus further comprises:
receiving a request for telemetry data from the RIC, wherein the request comprises the data type;
identifying telemetry data associated with the data type from the first sub-producer and the second sub-producer; and
connecting the message bus to receive the telemetry data associated with the data type from the first sub-producer and the second sub-producer and to provide the telemetry data to the RIC.

8. A computing system of a next-generation cellular network, the computing system comprising:
one or more processors; and
one or more memories storing instructions that, when executed by the one or more processors, cause the computing system to:
instantiate a message bus associated with a producer of telemetry data to a radio access network intelligent controller (RIC), wherein the producer comprises a plurality of individually managed sub-producers producing telemetry data, and wherein a subset of the telemetry data is provided by the message bus to the RIC based on a data type;
provide, via the message bus, first telemetry data associated with the data type from a first sub-producer of the plurality of individually managed sub-producers and second telemetry data associated with the data type from a second sub-producer of the plurality of individually managed sub-producers to the RIC;
cause generation of a recommendation for a third sub-producer of the plurality of individually managed sub-producers based on the first sub-producer, the second sub-producer, the first telemetry data, and the second telemetry data;
generate configuration instructions for the third sub-producer based on the recommendation, wherein the configuration instructions are associated with operational parameters of the third sub-producer; and
cause alteration of at least one of the operational parameters of the third sub-producer from a first state to a second state using the configuration instructions.

9. The computing system of claim 8, wherein, to cause generation of the recommendation, the one or more processors are further to: cause execution of at least one application external to the next-generation cellular network.

10. The computing system of claim 8, wherein the operational parameters of the third sub-producer include one or more of a hardware configuration, software configuration, and network setting.

11. The computing system of claim 8, wherein, to cause alteration of the at least one of the include operational parameters, the one or more processors are further to:
monitor third telemetry data from the message bus at the RIC; and
based on satisfaction of a criterion, cause alteration of the at least one of the operational parameters from the second state to the first state.

12. The computing system of claim 11, wherein the criterion is associated with allowable operating thresholds.

13. The computing system of claim 8, wherein the one or more processors are further to:
based on an indication of message bus failure, instantiate a replacement message bus;
connect the producer of telemetry data to the replacement message bus;
connect the RIC to the replacement message bus; and
cause transmission of the telemetry data from the producer of telemetry data to the RIC.

14. The computing system of claim 8, wherein, to instantiate the message bus, the one or more processors are further to:
receive a request for telemetry data from the RIC, wherein the request comprises the data type;
identify telemetry data associated with the data type from the first sub-producer and the second sub-producer; and
connect the message bus to receive the telemetry data associated with the data type from the first sub-producer and the second sub-producer, and provide the telemetry data to the RIC.

15. A radio access network intelligent controller (RIC) comprising:
a processing unit;
and a memory storing computer-readable instructions that, when executed by the processing unit, cause the RIC to:
receive, from a message bus, first telemetry data associated with a data type from a first sub-producer of a plurality of individually managed sub-producers and second telemetry data associated with the data type from a second sub-producer of the plurality of individually managed sub-producers;
generate a recommendation for a third sub-producer of the plurality of individually managed sub-producers based on the first sub-producer, the second sub-producer, the first telemetry data, and the second telemetry data;
cause generation of configuration instructions for the third sub-producer based on the recommendation, wherein the configuration instructions are associated with operational parameters of the third sub-producer; and
cause alteration of at least one of the operational parameters of the third sub-producer from a first state to a second state using the configuration instructions.

16. The RIC of claim 15, wherein to cause alteration of the at least one of the operational parameters, the RIC is further to:
monitor third telemetry data from the message bus at the RIC; and
based on satisfaction of a criterion, cause alteration of the at least one of the operational parameters from the second state to the first state.

17. The RIC of claim 16, wherein the criterion is associated with allowable operating thresholds.

18. The RIC of claim 15, wherein, to generate the recommendation, the RIC is further to cause execution of at least one application external to a next-generation cellular network.

19. The RIC of claim 15, wherein the operational parameters of the third sub-producer include one or more of a hardware configuration, software configuration, and network setting.

20. The RIC of claim 15, further comprising caching the first telemetry data and the second telemetry data in a local data store.
